(19) United States
(12) Patent Application Publication
(10) Pub. No.: US 2023/0383973 A1
(43) Pub. Date: Nov. 30, 2023

(54) Adaptive Temperature Control System for Garments and Methods for Controlling Temperature of Garments

(71) Applicant: Marc Evan Richelsoph, Arlington, TN (US)

(72) Inventor: Marc Evan Richelsoph, Arlington, TN (US)

(21) Appl. No.: 18/446,157

(22) Filed: Aug. 8, 2023

Related U.S. Application Data
(63) Continuation of application No. PCT/US2022/070588, filed on Feb. 9, 2022.
(60) Provisional application No. 63/278,765, filed on Nov. 12, 2021.
(60) Provisional application No. 63/147,363, filed on Feb. 9, 2021.

(51) Int. Cl. F24F 11/00; A41D 13/005; F24F 8/108

(52) U.S. Cl. CPC F24F 11/0008; A41D 13/005; F24F 8/108

(57) ABSTRACT

A self-contained apparel temperature control system includes a clamshell body comprising outer and inner components that, when connected, define an interior and an airflow passageway passing from an outside environment through the outer component, through the interior and outside the inner component to an inside environment and a cooling subassembly connected to one of the components and comprising a temperature sensor measuring a temperature value of the inside environment and electronically transmitting the temperature value, a fan moving air from an input side to an output side, and a controller communicating with the fan and the temperature sensor. The controller is programmed to receive the measured temperature value, to compare a set point temperature value with the measured temperature value and to turn off or on the fan dependent upon a comparison of the set point temperature value with the measured temperature value.

### CROSS-REFERENCE TO RELATED APPLICATIONS

This is a continuing application, under 35 U.S.C. § 120, of copending international application No. PCT/US2022/070588, filed Feb. 9, 2022, which designated the United States and was not published in English; this application also claims the priority, under 35 U.S.C. § 119, of U.S. Provisional Patent Application Nos. 63/278,765, filed Nov. 12, 2021, and 63/147,363, filed Feb. 9, 2021; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present disclosure relates generally to a temperature sensing and temperature managing system for use in clothing, body gear, coats, jackets, and other wearable goods having performance requirements where it is beneficial to manage a desired set temperature through active and passive control systems.

### BACKGROUND OF THE INVENTION

Outerwear, such as jackets or coats, are static combinations of fabrics and materials designed to insulate the wearer from outside temperatures or conditions.

For cold environments, companies have developed specialized fabrics. As can be seen in U.S. Pat. No. 8,424,119 to Blackford, a passive material and pattern is shown that reflects and conducts heat. Another variation of specialized fabric is also shown in U.S. Pat. No. 8,510,871 to Blackford et al. Of course, for cold weather, clothing includes layers of fabric and insulation to contain body heat. With or without specialized fabric, all these jackets are designed for static temperatures. This means that for the passive wearer, the insulative properties are supposed to be sufficient to maintain a given temperature if properly selected for the right environment and, if the wearer remains passive, a level of comfort will be maintained. However, if conditions change, such as the wearer is active and exerting some level of energy, or the outside temperature increases, the comfort level decreases as the temperature between the jacket and wearer increase.

Thus, a need exists to overcome the problems with the prior art systems, designs, and processes as discussed above.

### SUMMARY OF THE INVENTION

The present systems, apparatuses, and methods provide for a temperature control and monitoring system that create a stable temperature system to maintain a desired clothing-to-human interface temperature to make a more comfortable inside environment for the wearer.

An external opening and valve system is designed to open and close at certain temperatures to allow for external air flow to enter the clothing from the outside environment to provide dynamic air mixing within the clothing or within the air space between the wearer and the clothing (herein, the inside environment), thereby control temperature in or under the clothing. The temperatures at which the valve(s) open and close can be preset but, in an exemplary embodiment, are adjusted and set by the wearer.

Such systems, devices, and methods effectively create a personal contained temperature controlled environment that self-adjusts under changing conditions. Increases and decreases in activity, external air temperature, gaps between the wearer and the article of clothing can all be compensated for within the capabilities of the device.

The air control unit can be mostly passive, having at least one vent that can open based on temperature sensors, or active, whereby air is forced by a fan to distribute air where desired. The vent can also be a combination of at least one passive and one active vent.

There is provided a new clothing temperature control system for controlling and altering the temperature within clothing, such as a shirt, a jacket, a coat, a pair of pants, or person-coverable clothing such as a poncho, a scarf, a shawl, a cloak, and a blanket. As used herein, clothing or apparel are defined to include any wearable cloth-like item that is body-shaped or draped over the body; a number of different pieces of clothing and draped items are listed as examples herein. The clothing temperature control system directly controls the input of air from the external environment (also referred to as an input side) and allows a certain volume of the external air to enter the inside environment (also referred to as an output side) and mix with the internal air held within the apparel. For the purposes herein, apparel shall mean all personal attire, including coats, jackets, shirts, pants, boots, etc. By mixing air from the outside with air on the inside, the temperature can be controlled and maintained at a relatively constant rate. The air inside or within clothing, such as a shirt, a jacket, a coat, a pair of pants, or person-coverable clothing such as a poncho, a scarf, a shawl, a cloak, and a blanket is defined as the inside environment or microclimate.

In addition, the apparel temperature control system can monitor the outside and inside air temperatures as well as the internal heat rise rate to determine the best air mixing and air flow conditions to create a constant internal temperature, or one that declines or increases according to a program or user set level or pattern. Thus, the control system, with a built-in controller, microcontroller, or CPU can react and adjust to real time conditions as they occur. An electrical connection is made between the electronic components, such as the controller, the fan, any sensors, and any heaters and communication or transmission of data or values can be direct (e.g., wired) or wireless.

In one exemplary embodiment, a series of self-sealing louvers positioned in an opening are in a first position, such that the louvers are fully closed and louvers contact each other to create a substantially sealed opening such that air flow is restricted (e.g., >90% restriction) or cannot pass. The louvers pivot together in a controlled manner such that, when one louver opens, they are all connected and open approximately the same amount. An inexpensive bimetal thermostat can be set at a given temperature, and the expansion or shrinkage of the bimetal strip connected to the louvers causes the louvers to open and close.

In a second exemplary embodiment, a valve, which biased at rest in a closed position, can be opened by the pressure or vacuum of a small, lightweight, battery or solar-powered fan. An electronic thermostat is connected to at least one temperature sensor placed within the clothing (e.g., jacket), and, in particular, having more than one sensor in multiple locations. The wearer sets the desired temperature on the thermostat and when that temperature is reached, the fan turns on, drawing air past the valve and into or out from the clothing to mix outside and inside air to create the desired temperature environment.

In a third exemplary embodiment, a valve which at rest is in the closed position, can be electronically opened to allow air to passively enter or exit the clothing. An electronic thermostat is connected to at least one temperature sensor placed within the clothing, in particular, more than one sensor in multiple locations. The wearer sets the desired temperature on the thermostat and, when that temperature is reached, the valve opens, allowing air past the valve and into or out from the clothing to mix outside and inside air to create the desired temperature environment.

In another exemplary embodiment, the valve, louvers, intake, or exhaust is manually opened by the user.

In yet another exemplary embodiment the temperature sensing and regulation system can also combine control of the valve and heating elements within the clothing such that a comfortable temperature range can be maintained to handle different environments, such as a desert, glacier, forest, sports field, or Space Station.

The present systems, apparatuses, and methods provide a temperature control system where an air input can be opened and closed to control external air flow into or out of a jacket, clothing, fabric, or material construct.

The present systems, apparatuses, and methods provide a temperature control system where an opening extends through at least a portion of a piece of clothing, jacket, coat, pants or fabric, such that the opening extends to the outside environment.

The present systems, apparatuses, and methods provide a temperature control system where an opening or port allows for air to enter from an outside environment.

The present systems, apparatuses, and methods provide a temperature control system where an opening or port allows for air to exit out into an outside environment.

The present systems, apparatuses, and methods provide a temperature control system where an opening or port hidden behind a porous material allows for air to enter from an outside environment.

The present systems, apparatuses, and methods provide a temperature control system where an opening or port can be manually activated to allow for air to enter or exit a jacket, coat, clothing, blanket, boots, pants, or fabric construct to allow for external air to mix with the internal air.

The present systems, apparatuses, and methods provide a temperature control system where an opening or port is automatically activated at a set temperature range to allow for air to enter or exit a jacket, coat, clothing, blanket, or fabric construct to allow for external air to mix with the internal air.

The present systems, apparatuses, and methods provide a temperature control system where an opening or port is automatically activated at a set temperature range to allow for air to enter into or exit out from a channel, pocket, or air distribution configuration within a jacket, coat, clothing, blanket, or fabric construct to allow for external air to mix with the internal air and be distributed as desired.

The present systems, apparatuses, and methods provide a temperature control system where an opening or port, which allows for external air to enter or exit when in the open position, is normally in the closed and sealed position.

The present systems, apparatuses, and methods provide a temperature control system where an opening or port, which allows for external air to enter or exit when in the open position, remains in the closed and sealed position until the temperature control system opens or reopens the opening or port.

The present systems, apparatuses, and methods provide a temperature control system where an opening or port, which allows for external air to enter or exit when in the open position, remains in the closed and sealed position until the temperature control system opens the opening or port by activating a fan that creates a vacuum to pull the valve into the open position.

The present systems, apparatuses, and methods provide a temperature control system where an opening or port, which allows for external air to enter or exit when in the open position, remains in the closed and sealed position until the temperature control system opens the opening or port by activating a fan that creates a sufficient air flow force to open the valve.

The present systems, apparatuses, and methods provide a temperature control system whereby the temperature sensor is built into an independent unit that can be attached to fabric, jacket, clothing, coat, blanket, or other fabric material.

The present systems, apparatuses, and methods provide a temperature control system whereby at least one temperature sensor is placed remotely within the clothing, jacket, coat, etc., such that the temperature can be read at some distance away from the temperature controller.

The present systems, apparatuses, and methods provide a temperature control system whereby multiple temperature sensors are placed in different areas within the clothing, jacket, coat, etc., such that the temperature can be taken at multiple locations to create an average body temperature. For example, sensors can be located at the front and back of the torso. This can be one sensor, or multiple sensors placed at different points on the front and back to create a temperature map. Additional sensors in the arms, legs, neck, and/or head, such as in a cap or helmet can also provide data to the temperature control unit. This data can be managed and averaged or weighted as more or less important via the software.

The present systems, apparatuses, and methods provide a temperature control system whereby the desired user temperature is set manually.

The present systems, apparatuses, and methods provide a temperature control system whereby the desired user temperature is set electronically.

The present systems, apparatuses, and methods provide a temperature control system whereby the temperature control is BLUETOOTH® or WiFi® enabled, thereby permitting an external remote device, such as a watch, a smartphone, a pad, or any equivalent, allows for the temperature to be set through the remote device.

The present systems, apparatuses, and methods provide a temperature control system whereby the temperature control is BLUETOOTH® or WiFi® enabled, thereby permitting an external remote device, such as a watch, a smartphone, a pad, or any equivalent, allows for the temperature to be set through the remote device and the temperature range is monitored and recorded during a desired or set period of time.

The present systems, apparatuses, and methods provide a temperature control system whereby the temperature control is BLUETOOTH® or WiFi® enabled such that a remote device, such as a watch, a smartphone, a pad, or any equivalent, allows for the temperature to be set through the external device and the temperature range is monitored and recorded during a desired or set period of time and the collected date used to optimize the timing of the opening and closing of the air system.

The present systems, apparatuses, and methods provide a temperature control system whereby the temperature control system has at least one indicator light that activates when the unit is turned on to indicate power is active to the unit.

The present systems, apparatuses, and methods provide a temperature control system whereby the temperature control system has at least one indicator light that activates when the unit is turned on to indicate power is active to the unit and changes color to indicate power remaining in the battery.

The present systems, apparatuses, and methods provide a temperature control system whereby the temperature control system has at least one indicator light that activates when the unit is turned on, where the indicator light is in the shape of a ring, a circle a triangle, a square, a rounded square, a rectangle, a rounded rectangle, or other geometrical form.

The present systems, apparatuses, and methods provide a temperature control system whereby the temperature control system has at least one indicator light that activates when the unit is turned on, where the indicator light is in the shape of a ring or other geometrical form and the color of the indicator light can be set by the user either on the device or by a remote device.

The present systems, apparatuses, and methods provide a temperature control system whereby the temperature control system is attached to a fabric surface such that a portion extends beyond the fabric surface.

The present systems, apparatuses, and methods provide a temperature control system whereby the temperature control system is attached to a fabric surface such that a portion extends beyond the fabric surface external to the jacket, clothing, blanket, or apparel.

The present systems, apparatuses, and methods provide a temperature control system whereby the temperature control system is attached to a fabric surface such that a portion extends beyond the fabric surface external to the jacket, clothing, blanket, or apparel and is flush to the inside surface.

The present systems, apparatuses, and methods provide a temperature control system whereby at least part of the temperature control system is attached to a fabric surface through an opening such that a portion of the temperature control unit extends beyond the fabric surface opening external to the jacket, clothing, blanket, or apparel and extends past the inner attachment surface.

The present systems, apparatuses, and methods provide a temperature control system whereby the temperature control system is removably attached to a fabric surface.

The present systems, apparatuses, and methods provide a temperature control system whereby at least part of the temperature control system is removably attached to a fabric surface.

The present systems, apparatuses, and methods provide a temperature control system whereby the temperature control system maintains a preset temperature or preset range within a jacket, coat, blanket, or other piece of apparel.

The present systems, apparatuses, and methods provide a temperature control system whereby the temperature control system monitors the temperature within a jacket, coat, blanket, or other piece of apparel and compensates a rate of temperature rise according to a program that alters the volume of air input to allow for constantly changing air mixing according to physical conditions of the user.

The present systems, apparatuses, and methods provide a temperature control system whereby the temperature control system comprises a filter and monitors the temperature within a jacket, coat, blanket, or other piece of apparel by allowing filtered air to enter the apparel.

The present systems, apparatuses, and methods provide a temperature control system whereby the temperature control system monitors the temperature within a jacket, coat, blanket, or other piece of apparel by allowing filtered air and preventing rain from entering the apparel.

With the foregoing and other objects in view, there is provided, a self-contained apparel temperature control system comprising a clamshell-type body comprising an outer component and an inner component that, when connected together, define a hollow interior and an airflow passageway passing from an outside environment through the outer component, into and through the hollow interior, and through and outside the inner component to an inside environment and a cooling subassembly connected to one of the outer and inner components. The cooling subassembly comprises at least one temperature sensor configured to measure a temperature value of the inside environment and to electronically transmit the measured temperature value, a fan configured to move air from an input side to an output side, and a controller electronically connected to the fan and to the at least one temperature sensor. The controller is programmed to receive the measured temperature value, to compare a set point temperature value with the measured temperature value, and to turn off or on the fan dependent upon a comparison of the set point temperature value with the measured temperature value. The body is sized to be attached to apparel of a user. The outer component is configured to attach to the inner component with the outer component adjacent an outer surface of the apparel in the outside environment of the user and the inner component adjacent the inner surface of the apparel in an inside environment of the apparel adjacent the user. The measured temperature value is a temperature of the inside environment and, responsive to being turned on, the fan moves air from the outside environment to the inside environment.

With the objects in view, there is also provided a self-contained apparel temperature control system comprises a clamshell-type body comprising an outer component and an inner component that, when connected together, define a hollow interior and an airflow passageway passing from an outside environment through the outer component, into and through the hollow interior, and through and outside the inner component to an inside environment and a cooling subassembly connected to one of the outer and inner components. The cooling subassembly comprises at least one temperature sensor configured to measure a temperature value of the inside environment and to electronically transmit the measured temperature value, a fan configured to move air from an input side to an output side, and a controller electronically connected to the fan and to the at least one temperature sensor. The controller is programmed to receive the measured temperature value, to compare a set point temperature value with the measured temperature value, and to turn off or on the fan dependent upon a comparison of the set point temperature value with the measured temperature value.

In accordance with another feature, the temperature of the inside environment is controlled by regulating a volume of air entering from the outside environment.

In accordance with a further feature, the airflow passageway defines an outside environment inlet and which further comprises a valve disposed between the input side of the fan and the outside environment inlet and configured to prevent air from entering the inlet.

In accordance with an added feature, the valve is configured to open while the fan is running.

In accordance with an additional feature, there is provided a piece of apparel, the outer and inner components clamped together on opposing sides of the apparel, the outer environment being the environment outside the apparel and the inner environment being the environment inside the apparel, and, responsive to being turned on, the fan forces air into the inner environment from the outer environment.

In accordance with yet another feature, the airflow passageway defines an outside environment inlet and an inside environment outlet and the apparel comprises at least one of openings and channels fluidically connected to the inside environment outlet such that, responsive to the fan being turned on, air is forced by the fan through the at least one of openings and channels to be distributed about various locations within the inner environment.

In accordance with yet a further feature, the at least one temperature sensor comprises an inside environment temperature sensor and an outside environment temperature sensor, the inside environment temperature sensor is configured to measure an inside temperature value of the inside environment and to electronically transmit the measured inside temperature value to the controller, the outside environment temperature sensor is configured to measure an outside temperature value of the outside environment and to electronically transmit the measured outside temperature value to the controller. The controller is electronically connected to the fan and to the inside and outside temperature sensors and is programmed to receive the measured inside and outside temperature values, to compare the measured inside and outside temperature values, and to turn off or on the fan dependent upon a comparison of at least two of the set point temperature value, the measured inside temperature value, and the measured outside temperature value.

In accordance with yet an added feature, the at least one temperature sensor comprises a humidity sensor configured to measure a humidity value of the inside environment and to electronically transmit the measured humidity value to the controller and the controller is programmed to receive the measured humidity value, to compare a set point humidity value with the measured humidity value, and to turn off or on the fan dependent upon a comparison of the set point humidity value with the measured humidity value.

In accordance with yet an additional feature, the controller is programmed to periodically receive the measured temperature value and to compare the set point temperature value with the measured temperature value and to turn off and on the fan periodically to keep the measured temperature value at a given value. The given value is user-adjustable.

In accordance with again another feature, the fan is a variable speed fan and the controller is programmed to control a speed of the variable speed fan to optimize a volume of air entering the inside environment.

In accordance with again a further feature, the controller is programmed to keep the interior temperature at a given temperature and to keep the interior humidity at a given humidity.

In accordance with again an added feature, the given temperature and the given humidity are each user-adjustable.

In accordance with again an additional feature, there is provided a wireless communication device operatively connected to the controller and configured to receive the set point temperature value and provide it to the controller and a remote control configured to wirelessly transmit the set point temperature value to the controller.

In accordance with still another feature, there is provided a plurality of apparel temperature control devices each comprising the body and the cooling subassembly.

In accordance with still a further feature, there are provided wireless communication devices each operatively connected to the controller of each of the plurality of temperature control devices and configured to receive a set point temperature value and provide it to a respective controller and a remote control configured to wirelessly transmit the same set point temperature values to the wireless communication devices.

In accordance with still an added feature, there are provided wireless communication devices each operatively connected to the controller of each of the plurality of temperature control devices and configured to receive a respective set point temperature value and provide it to a respective controller and a remote control configured to wirelessly transmit set point temperature values to each of the wireless communication devices.

In accordance with still an additional feature, there is provided at least one heating element operatively connected to the controller, the controller programmed to power the heating element dependent upon a comparison of the set point temperature value with the measured temperature value.

In accordance with still an additional feature, the airflow passageway defines an inside environment outlet and which further comprises tubing fluidically connecting the inside environment outlet to different locations within the inside environment.

In accordance with still an additional feature, the tubing is constructed from a flat sheet of material formed to create a flexible tube and coated with a non-porous flexible coating.

In accordance with a concomitant feature, the body is sized to be attached to apparel of a user, the outer component is configured to attach to the inner component with the outer component adjacent an outer surface of the apparel in the outside environment of the user and the inner component adjacent the inner surface of the apparel in an inside environment of the apparel adjacent the user, the measured temperature value is a temperature of the inside environment, and, responsive to being turned on, the fan moves air from the outside environment to the inside environment.

Although the systems, apparatuses, and methods are illustrated and described herein as embodied in the adaptive temperature control system, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 is a front perspective view of an exemplary embodiment of an apparel temperature control system having a valve and controls;

FIG. 2 is a rear perspective view of an exemplary embodiment of a temperature control system having a fan;

FIG. 3 is a rear, partially exploded, perspective view of an exemplary embodiment of a valve configuration within a portion of the temperature control system;

FIG. 4 is a front perspective view of an exemplary embodiment of a temperature control system mounted to an outdoor jacket or coat;

FIG. 5 is a front perspective view of an exemplary embodiment of an apparel temperature control system having a valve, controls, and a filter;

FIG. 6 is a partially exploded view of an exemplary embodiment of a temperature control system having a valve, controls, and a filter;

FIG. 7 is an exploded view of an exemplary embodiment of a filter unit;

FIG. 8 is a perspective view of an exemplary embodiment of an apparel temperature control system;

FIG. 9 is a partially exploded, perspective view of the temperature control system of FIG. 8 with a removable section;

FIG. 10 is a partially exploded, perspective view of an exemplary embodiment of temperature control unit with built-in fan or blower;

FIG. 11 is a top perspective view of an exemplary embodiment of an upper section of an apparel temperature control system;

FIG. 12 is a bottom perspective view of the upper section of FIG. 11;

FIG. 13 is a cross-sectional view of the upper section of FIG. 11;

FIG. 14 is a bottom perspective view of the upper section of FIG. 11 with a fan and a sensor;

FIG. 15 is a top perspective view of an exemplary embodiment of a bottom section of a temperature control unit;

FIG. 16 is a bottom perspective view of the bottom section of FIG. 15;

FIG. 17 is a cross-sectional view of the bottom section of FIG. 15;

FIG. 18 is a top perspective view an exemplary embodiment of an assembly of a temperature control system;

FIG. 19 is a front perspective view an exemplary embodiment of a valve component of a temperature control system;

FIG. 20 is an exploded view of an assembly of an exemplary embodiment of a temperature control system;

FIG. 21 is a partially exploded, perspective top view of an assembly of an exemplary embodiment of a temperature control system with an air distribution channel unattached;

FIG. 22 is a perspective top view of the assembly of FIG. 21 with the air distribution channel attached;

FIG. 23 is a perspective top view of an exemplary embodiment of a top component of an apparel temperature control system;

FIG. 24 is a perspective bottom view of the top component of FIG. 23;

FIG. 25 is a perspective top view of a bottom component of a temperature control system.

FIG. 26 is a perspective bottom view of an exemplary embodiment of a bottom component of the temperature control system;

FIG. 27 is an exploded perspective view of an exemplary embodiment of an assembly of the temperature control system;

FIG. 28 is a perspective side view of the assembly of FIG. 27;

FIG. 29 is a cross-sectional view of the assembly of FIG. 27; and

FIG. 30 is an exploded, perspective view of a piece of clothing with a number of the temperature control systems placed on various locations of the clothing.

### DETAILED DESCRIPTION OF THE EMBODIMENTS

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems, apparatuses, and methods will not be described in detail or will be omitted so as not to obscure the relevant details of the systems, apparatuses, and methods.

Before the systems, apparatuses, and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

It will be appreciated that embodiments of the systems, apparatuses, and methods described herein may be comprised of one or more conventional processors and unique stored program instructions that control the one or more processors to implement, in conjunction with certain non-processor circuits and other elements, some, most, or all of the functions of the systems, apparatuses, and methods described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system or programmable device. A “program,” “software,” “application,” “computer program,” or “software application” may include a subroutine, a function, a procedure, an object method, an object implementation, an executable application, an applet, a servlet, a source code, an object code, any computer language logic, a shared library/dynamic load library and/or other sequence of instructions designed for execution on a computer system.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

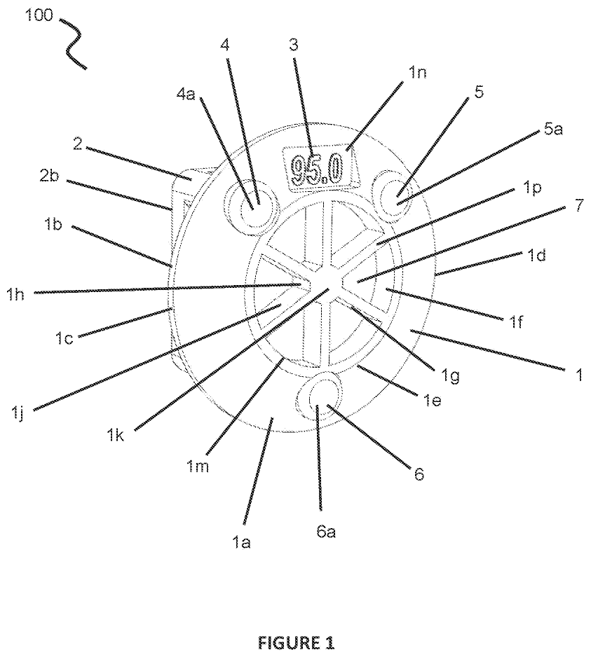

Described now are exemplary embodiments of the present systems, apparatuses, and methods. Referring now to the figures of the drawings in detail, there is shown a first embodiment of the apparel temperature control system, illustrated generally at 100, as shown in FIG. 1. The case 1 has a front face 1a, back face 1b, outer face 1c, outer edge 1d, and inner edge 1e. In this example, the front face 1a is tapered or chamfered from outer edge 1d to inner edge 1e. This creates a sleek look while reducing material weight. Multiple inner openings comprise faces 1f, 1g, 1j, and 1h that create spokes 1p that support a central hub 1k. In this example, there are 6 openings and 6 spokes. This number can be altered for structural or ornamental reasons. The openings create an edge 1m. While edge 1m and inner edge 1e could overlap, machining or molding tolerances could make a singular line or curve having variations. By leaving a gap, the look is more consistent and avoids the possibility of a somewhat sharp edge. A cut-out or location 1n is provided for a digital display. This can be cut in from the front for mounting the display, or cut in from the back. The case 1 could also be molded from transparent or translucent material such that the display would show through front face 1a. A fan 2 having a rear face 2b is connected to the case 1. This can be connected by hardware, adhesives, or ultrasonic welding, for example. In addition, the case 1 and fan 2 can be assembled as a single unit for insertion into the apparel or the fan 2 be attached after, wedging the fabric between the fan 2 and the case 1. A digital display 3 can display any or all of the set temperature, the internal and external temperatures, the battery life, messages, and any other necessary display information. The size of the display and its location can be altered from that shown in FIG. 1. A control button 4 having a touchable surface 4a is used to provide user input to the electronics. This control button 4 can be a standard push button that, by pressing, causes contacts to touch, as in a membrane switch, or can be a button activated by electrostatic discharge. A control button 5 has a touchable surface 5a, and a button 6 has a touchable surface 6a. In this configuration, button 4 controls decreasing the temperature, button 5 controls increasing the temperature, and button 6 turns the unit on and sets the baseline temperature. Of course, combinations of pressing more than one button simultaneously can create other functions, such has different data readouts or setting a temperature pattern or recalling a preexisting temperature or pattern, to name a few. In addition, the functions of the buttons can be swapped and more or less buttons used as needed to add or subtract functions. With wireless connection (e.g., BLUETOOTH®) to a remote device, such as a smart watch, a button or buttons can be eliminated, as control of the unit can be done remotely. In this embodiment, when button 6 is pressed, the temperature sensing unit starts monitoring the internal apparel temperature to determine an initial baseline temperature. This provides the starting reference for a comfortable internal apparel temperature. Once the baseline is established, it can be adjusted up or down, according to user preference.

The shape of the case can be other shapes, including but not restricted to a square, a rectangle, an oval, or a multi-sided polygon, such as a pentagon, hexagon, octagon, or other desired shape.

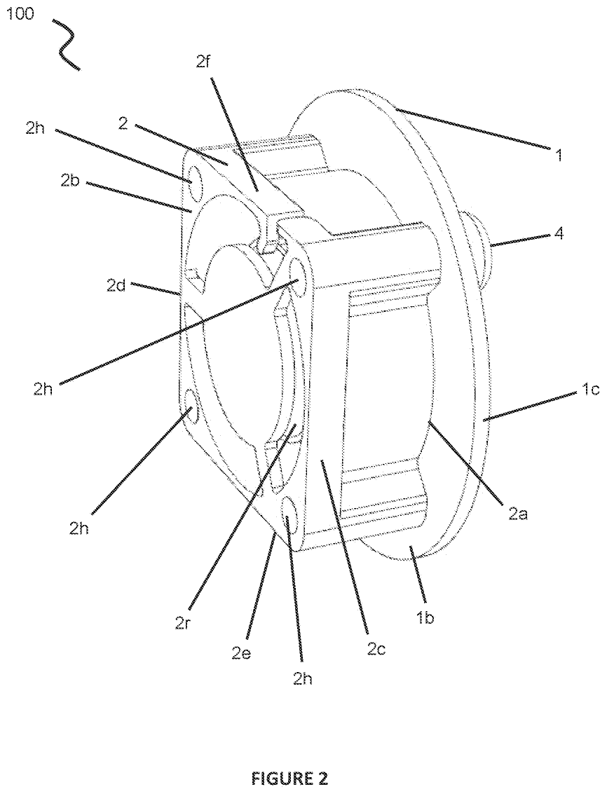

In FIG. 2, the back of the apparel temperature control system 100 is shown in more detail. The fan 2 is connected to the case 1 by mechanical, adhesive, or ultrasonic welding, as examples. In a beneficial exemplary embodiment, the fan 2 is attached mechanically so it can easily be replaced, if necessary. The fan 2 has a front face 2a, back face 2b, a first side 2c, second side 2d, a bottom face 2e, and a top face 2f. Mounting holes 2h allow for mechanical fastening, if desired. The fan rotor 2r is connected to the non-illustrated, integral fan motor. The fan 2 can be constructed with a DC brush motor or, in particular, a DC brushless motor. It is noted that the size of the fan can be very small and that the drawing figures are only representative of the various embodiments. The fan 2 can also be a blower design, depending on the configuration and size.

Choosing which fan to use is a balance of characteristics. Air flow volume, size, weight, and pressure capability are all key to performance. Insufficient air flow will not allow for cooling to keep pace with heat and/or humidity extraction. Insufficient air pressure would not allow for air to move freely around the body or move through tubing. In one embodiment, the tubing is constructed from flat material. This tube remains flat until sufficient pressure and air flow from the fan inflates it, making fan characteristics key elements. At the same time, weight, size, power and power consumption create practical restrictions. For an athlete, every gram is more weight they must carry, which can affect performance. Too large, and the temperature control system may interfere with motion or make it uncomfortable to wear. Drawing too much power requires larger and heavier batteries. Therefore, it is important to choose a fan or blower as small and light as possible that meets all the needed characteristics. Ideally, a fan or blower that falls within a size range of 17 mm×17 mm×8 mm to a maximum of 40 mm×40 mm×10 mm is preferred. This covers an air flow range of 0.9 cubic feet per minute to 8.0 cubic feet per minute, with weight ranging from approximately 3.9 grams to 15.6 grams. The specific fan within this range can be chosen to meet the remaining characteristics. Additional selectable characteristics include dust resistance along with moisture and water resistance. These fans are all available with speed control.

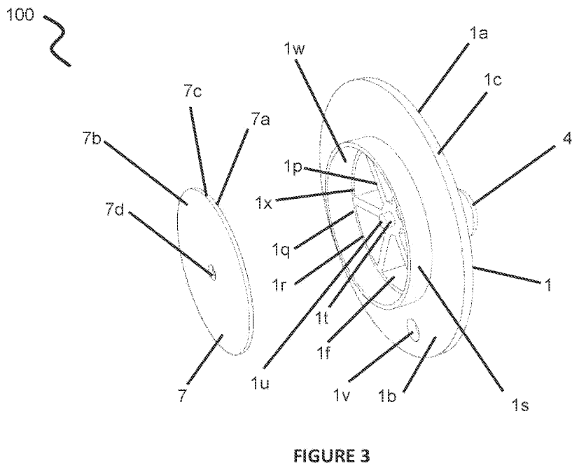

In FIG. 3, the back of the apparel temperature control system 100 is shown without the fan. The case 1 shows the continuation of the openings and spokes through the case that open into chamber 1w. Chamber 1w is larger than the diameter of face 1f, which creates a lip with an inner edge 1r and outer edge 1q, and a flat surface 1x. External surface 1s is a ring that extends from the back surface 1b. A connector 1v provides a singular port for connection of the wiring to the rest of the system. A central post 1t with a top surface 1u fits within a hole 7d of the valve 7 to center the valve 7 within the chamber 1w. The valve 7 is a flexible polymer disc having a front face 7a, back face 7b, edge 7c, and the hole 7d. In a normally closed position (e.g., steady state), the polymer front face 7a seals against flat surface 1x. When the fan 2 draws a vacuum, the polymer disc elastically distorts, allowing air to pass by the valve 7. By placing the fan 2 behind the polymer disc of the valve 7, a debris and fan blade guard is built in. Of course, the fan 2 can be placed in front of the valve 7 such that pressure is used to force the polymer disc open.

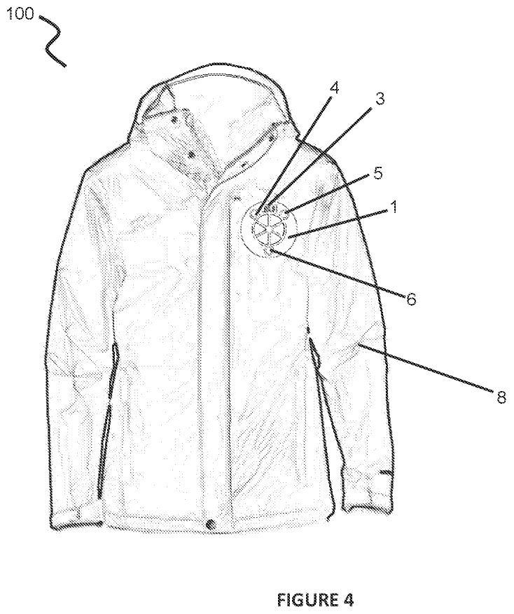

In FIG. 4, the exemplary embodiment of the apparel temperature control system 100 is shown attached or mounted to clothing 8 in the exemplary form of a jacket. In this example, the case 1 is attached to the jacket at the left breast. The size of the apparel temperature control system is shown in FIG. 4 as a large unit, in a particular embodiment, the unit is smaller. The unit is out of scale in FIG. 4 in order to show more details of the unit. When the fan 2 is activated, air is pulled past the valve 7 and through the openings in the case 1. This air is blended with the air inside the jacket 8. While this air can be directly brought into the jacket 8 and blown directly against the wearer, in a particularly useful embodiment, the air from the fan is directed to pre-set desired locations. A liner having channels with distributed porosity or holes, for example, provides air distribution over a larger area. While not necessary, it is beneficial to have at least a partial seal or excellent fit around the bottom of the jacket to the wearer, which can be accomplished with a snow skirt type fabric component that contracts around the body. This can also be accomplished by including an elastic liner that expands or contracts to fit as the wearer zips or closes the jacket. A further mechanical embodiment includes or add a lower drawstring to cinch the bottom edge of the jacket 8, or a circumference above the bottom edge, around the user.

In an exemplary embodiment, the apparel temperature control system 100 is powered by a battery, in particular, a light-weight, high-energy density, lithium-ion battery or better technology. The goal in preferring such technology is to keep the weight down while providing a reliable power source. For long outings, solar cells/panels can be attached to the apparel and be connected to the temperature control system 100 to allow for recharging while wearing the apparel or for recharging after such wear. Flexible solar cells or panels can be matched to fit curves, such as the shoulders of the apparel 8. Together, the fan, the sensor, and the controller comprise a cooling subassembly of the apparel temperature control system 100.

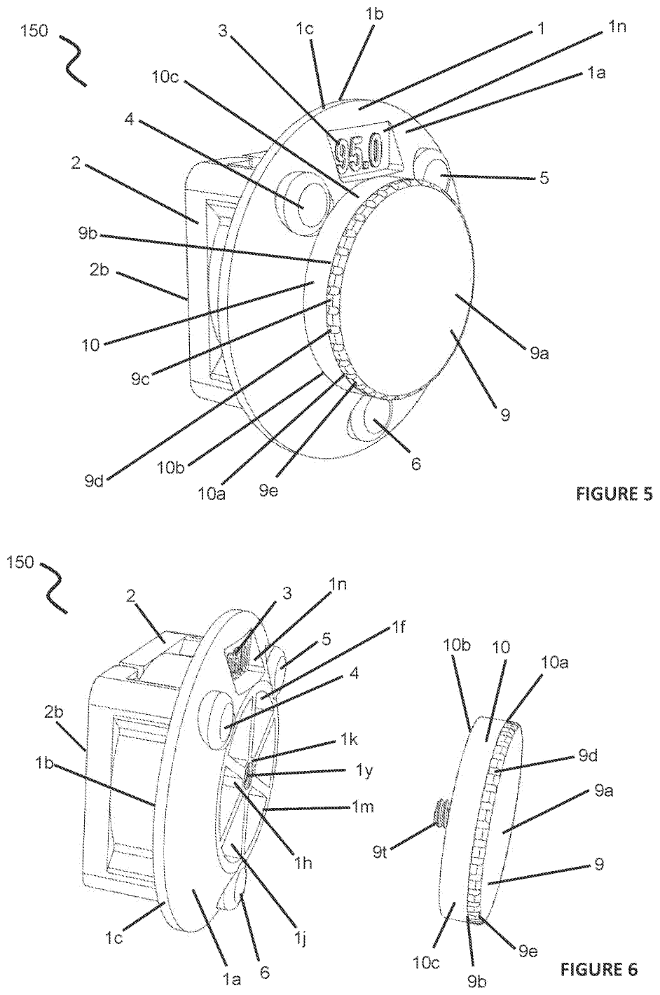

FIG. 5 shows a further exemplary embodiment of an apparel temperature control system 150. In this embodiment, a filter unit 10 has been added to the front (i.e., the side facing out from the user) of the temperature control unit 1. A front cover and filter holder 9 of the filter unit 10 has a front face 9a, a back face 9b, an external surface 9c, and grooves 9d. The filter unit 10 has a front face 10a, a back face 10b, and an outer diameter surface 10c. The filter unit 10 is constructed from a non-illustrated porous filtering media that allows for air to pass through but removes dirt and debris. The media can be, for example, a porous polymer, a filter paper construct, and natural porous materials to name a few. In addition, material for the filter can be hydrophobic, thereby shedding water off the filter while allowing air to enter and pass through. Such a configuration is ideal for wet environments or the unexpected rain storm. The filter unit 10 prevents debris from entering the temperature control unit 1 and the apparel, in particular protecting the unit while keeping debris outside of the apparel.

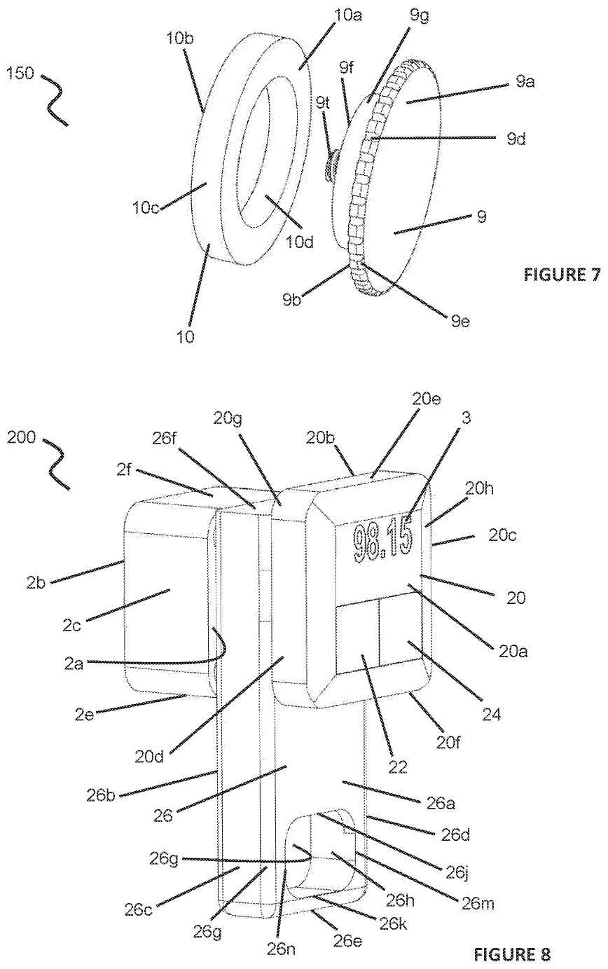

FIGS. 6 and 7 show more details of the apparel temperature control system 150. The front cover and filter holder 9 has a threaded connection 9t that matches the threads 1y on the temperature sensing unit 1. In this example, the material of the filter is in the shape of a ring. An inner bore 10d of the ring slides over cylinder 9g of the front cover and filter holder 9. Cylinder 9g has a front face 9f The ring of the filter material can be compressible such that, as threads 9t and 1y are engaged and tightened, the filter material compresses against front face 1a and/or between the flat face created on the front between inner edge 1e and edge 1m. The screw on-and-off capability of this filter unit 10 makes it easy to replace. There are other ways to add the filter, including having the filter unit attach by a bayonet connection or to have a non-illustrated pocket already attached to the front 1a of the temperature control unit 1 such that the filter material (e.g., the ring) can be slid into the pocket. Also, the front cover and filter holder 9, itself, can be constructed from a porous material or it can have openings to allow for more air to pass.

FIG. 8 shows an apparel temperature control system 200 with the fan and an air input in a different configuration to accomplish the same goal. In this example, the temperature control unit 20 is square with a front surface 20a, back surface 20b, a first side 20c, second side 20d, top surface 20e, and lower surface 20f. The display 3 is attached to, recessed into, or secured from the inside of the front face 1a. The edge of the front face 1a is chamfered 20h, with corner radii 20g. These features give the unit a clean look, but can be altered as needed, as can the shape in general. Switches 22 and 24 control the function of the unit. As per the previous design, they can be membrane switches, push buttons, or other types of switches. An air flow channel 26 has a front face 26a, back face 26b, a first side 26c, second side 26d, bottom face 26e, and top face 26f. An opening 26h has a top surface 26j, bottom surface 26k, a first side 26m, and second side 26n. The opening continues from the front face 26a to the back face 26b. While this opening is shown as a rectangle, it can be other shapes, including round, square, or any other geometrical shape. The inside of the air flow channel 26 is hollow, to allow air to enter through opening 26h and be pulled up and into the apparel by the fan. A valve to keep air out when the fan is not working can be in the same configuration as the previous embodiment or contained within air channel 26. The valve can be one of a number of valves, including a flap valve that pivots up and down, closing off the air flow channel 26. In an exemplary embodiment of the valve, gravity is used to keep it in the down position when there is no air flow, and the flap can also be flexible such that the force from the flap material is springy enough to create some downward force to assist in sealing. A spring can also be used, if necessary or desired. There are other types of valves, including ball valves, duck bill valves, etc., that can be fit within the air flow channel 26. This configuration can also accept filter material into the opening 26h, or an additional opening can be added to the top 26f to allow for sliding in filter material or a filter cartridge. The valve can also be used to keep water out, such as in extreme conditions where the air intake is submerged.

By placing the air intake opening below the fan or blower, any rain has to flow upwards in order to enter the apparel. The amount of air moved by the fan or blower is not extreme. This means that most, if not all, of any small amounts of water, simply never make it up the air channel, allowing the inside of the jacket to remain dry even in heavy rain. Of course, a flap of fabric, plastic, or rubber over the opening that is porous or allows air to flow can also be used to help keep out rain and dust.

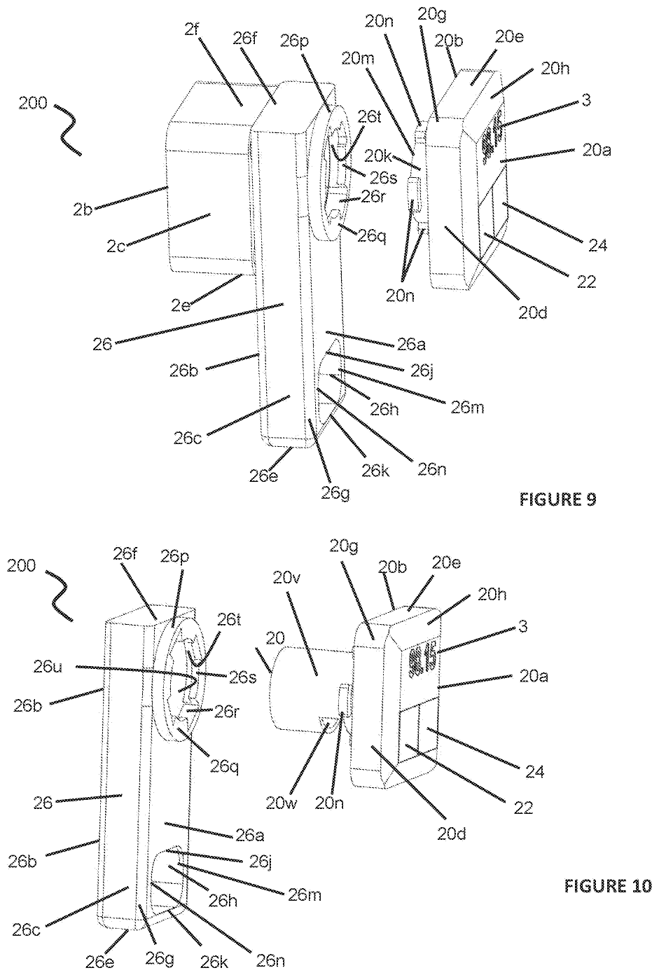

In FIG. 9, it can be seen that the temperature control unit 20 is removable from the air flow channel 26. While there are multiple ways to configure this, including tabs, snap in tabs, threads, a retention set screw, etc., this example uses a bayonet approach. One or more teeth 20n extend from a cylinder 20k, which has a front face 20m. The air flow channel 26 has an extension 26p that has a front face 26q, openings 26r for accepting the teeth 20n, and a groove 26t, which allows the teeth 20n to rotate therewithin. To attach the temperature control unit 20, the unit 20 is turned at an angle to align the grooves 26r and the teeth 20n. The unit 20 is pushed in and turned to engage the bayonet features to secure the unit 20 to the air flow channel 26.

In FIG. 10, the fan unit is built into an extended cylindrical portion 20v, in contrast to FIG. 9. An air input opening 20w aligns with the hollow opening within air channel 26, such that when temperature control unit 20 is properly positioned, air can freely flow through the fan and opening 26h, and past the valve. The advantage of embodiment is that all the key electronics can be contained within the temperature control unit 20. Thus, when the unit 20 is removed, the apparel can be washed without affecting the electronics.

The air flow channel 26 can also be a shorter tube, long enough to contain the valve and necessary attachments, but with an open end that connects to a fabric tube or pocket that has an opening or porous covering to let air in. Such a configuration allows for many variations based on the thickness or type of the apparel.

One or more temperature sensors can be connected to one or more contacts that are built into the air flow channel 26. Thus, when the bayonet is turned, or another locking mechanism engaged, the contacts touch, creating the necessary circuit(s) to activate the sensors. The battery, depending on power draw, can be built into the temperature control unit 1, 20, or contained separately within a pocket or pouch in the apparel and electrically connected to the unit 1, 20 when the unit 1, 20 is secured to the apparel. Should it be desired, heating elements can be added within the apparel, and the temperature control unit 1, 20 can turn the heating elements on and off as needed to meet higher temperature requirements.

By placing multiple temperature sensors within the apparel, an accurate map can be made to control and set the desired temperature. Of course, one sensor can be used, but more than one sensor can provide a better overall picture. In an exemplary embodiment the output voltage of the temperature sensor(s) varies according to the temperature of the environment in which the sensor resides. A controller of the temperature control unit 1, 20 (e.g., a CPU) can read each sensor and come up with an average, or the software can adjust the result by weighting the value of a particular sensor to come up with a weighted average. The adjustment(s) can be automatic or the user can make adjustments as needed. For example, a jacket 8 is set-up with four temperature sensors. These sensors can be infrared, contact, thermocouples, etc. For the purposes of this example, the four sensors are Type K waterproof thermocouples. They are small, precise, react quickly to temperature changes, inexpensive, and can be left in the jacket when it is washed. By placing the four sensors in different locations, such as the upper back, the lower back, the chest, and the stomach, it is likely each sensor will register a different temperature. The temperature controller sends power to the thermocouples and measures the voltage returning from each thermocouple. With data from the four sensors, an accurate internal jacket temperature map is generated. Taking this one step further, if the jacket is open at the bottom and the lower back sensor is close to the bottom, the temperature may vary greatly from the others. The controller can measure this periodically, constantly, or on a user-set schedule and compare the measurement to the other sensors. The controller software program can then use the data as-is, or weight it, such that one or more readings become less important than one or more of the others, or valued higher. With data collected and treated according to the controller software, the controller has enough information to control the fan or blower to turn on and off as well as to adjust a speed of the fan or blower. If the jacket is equipped with a heating element(s) and the temperature drops to a set point or below, the temperature controller can also regulate that heating element(s).

By including another sensor in this example, the thermocouple can be placed to measure air temperature in the outside environment. With this, the controller has more complete data on the internal and external conditions. This allows for the controller and software to determine how much external air should be mixed with inside air and control this through fan speed and/or turning the fan on or off. In cold environments, if the jacket interior is too hot, adding cold air in slowly and in a controlled manner lead to a more accurate and stable internal environment, minimizing or eliminating overshooting the desired temperature by adding too much cold air.

Sensors for temperature and humidity are readily available. Examples include DHT22 by Aosong, TMP36 by TMP, DS18B20, by Dallas, and a series of sensors by SENSIRION AG, including SHT11, SHT40, and SHT85 among others. Some of the SENSIRION AG sensors are also water resistant to the IP67 standard. This allows for the sensor to be submerged up to 1 meter in water for up to 30 minutes, allowing the sensors to remain in place in the jacket or apparel for the purposes of washing or exposure to rain. When used herein, measuring a temperature or a temperature value means that a reading is taken that corresponds directly or indirectly to the temperature of the particular environment, e.g., the outside or inside. A given sensor may return a voltage value, for example, which may not be equal to a temperature but it is a value that can correspond to a temperature value that the controller can receive (wired or wirelessly) and interpret as a particular temperature.

In certain applications, such as heavy physical exertion or certain medical conditions, such as menopause related hot flashes, sensing humidity maybe just as important as or more important than sensing temperature. By using a sensor to detect humidity, the temperature control unit can respond directly to humidity changes, increasing or decreasing air flow to cool the skin by circulating air to cause evaporation of perspiration.

In general, the embodiments can use either a fan or blower to meet the air flow requirements. Furthermore, as the fan or blower is moving the air, the temperature controller unit 1, 20 can have a built-in heating element. For example, in FIG. 10, extended cylindrical portion 20v can contain one or more heating elements. When heat is required, the temperature control unit 20 turns on power to the heating elements. Because air flow distributes the heat, this method of heating is more uniform than jackets having fixed heating elements, which can only heat up sections of the jacket. The amount of power controls how hot the heating element temperature reaches. Of course, when using heating elements, the power requirements increase, and so does the size of the battery. Weight must be carefully considered against heating requirements to avoid the risk of the apparel becoming uncomfortably heavy. It is also possible to add cooling, such that the air coming in is cooled as it passes over or through a heat exchanger, with the cooling coming from one or more Peltier modules, for example, or other alternative cooling system. However, this brings issues of weight, power draw, and the need to dispense of the heat generated by the Peltier module(s). Together, the fan, the sensor, and the controller (as well as the optional heating element(s)) comprise a cooling subassembly of the apparel temperature control system 200.

For apparel constructed with materials that do not absorb perspiration, such as waterproof membranes, the temperature control systems described herein have additional value. Waterproof membranes can be uncomfortable, as perspiration builds up and makes the fabric uncomfortable to wear. The temperature control unit 1, 20 can be used to force air into the apparel to reduce the humidity inside the jacket and make the jacket much more comfortable. Also, in combination with or in place of the temperature sensors, at least one humidity sensor can be built into the temperature control unit or in the apparel.

The novel invention described herein has significant value for the normal wearer as well as for extreme users bearing extraordinarily high activity levels. For example, an individual decides to walk an arduous trail with an outdoor starting temperature of 45 degrees F. The outdoor environment is also changing temperature and increasing to 50 degrees over the length of the walk. If the wearer chooses to dress for the start temperature, they will be uncomfortably hot at some point during the walk. Exertion energy generates heat, which, with the outdoor increasing heat, will likely require unzipping the jacket, removing layers, or removing the jacket. Dressing for the end temperature means the start of the walk is uncomfortably cold. By using the temperature control system, as the temperature increases for the wearer, the unit compensates and effectively provides cooling at a time when it is needed. The reverse is also true when the environment starts out warmer and becomes colder. Instead of the temperature control unit 1, 20 coming on during the hike, the unit 1, 20 can start cooling and slowly shut down as the environment becomes cooler. This allows the wearer to start with warmer apparel or more layers at the start, and later saving stops along the way to adjust while maintaining a desired temperature. As the system 100, 150, 200, 300, 400 can monitor the wearer's temperature as well as the outside air temperature, as long as the temperature differential is in the proper direction, internal temperature can be maintained. In addition, the unit can include a heating unit or elements that can be controlled by the temperature control unit 1, 20 to further compensate for cold conditions.

There are other manual ways of accomplishing the task of temperature control described herein. A bimetal strip expands and contracts as the environment temperature around the bimetal strip changes. This mechanical approach can be used to pull and push on louvers, to open or close a gate, or to open/close another mechanical device. The temperature can also be set manually by turning a dial that adjusts tension on the bimetal strip. The measure for heat exchange can simply be a port in the apparel that opens to allow air in or out, or can be used with the fan or blower, as in the configurations described herein. If used with a fan or blower, when air is allowed to flow, a contact or switch can automatically turn on the fan. Of course, in its simplest form, the air opening can be opened and closed manually. While this may not be the most efficient manner of temperature control, it is very inexpensive to add to apparel.

FIGS. 11 through 22 show another exemplary embodiment of an apparel temperature control system 300. Specifically, FIG. 11 shows a top component 30 having a top surface 30a, a bottom face 30b, an external cylindrical wall surface 30c, and a front face 30d. A chamfer or angled face 30e connects the top face 30a to the wall surface 30c. At the intersection edge of the top face 30a and the angled face 30e, a blend radius 30f smooths the transition and eliminates any sharp edge. The geometry can be different and, for example, be oval, square, multi-sided, such as octagonal, or a variety of other shapes. A central support 30g provides support to the front face 30d after the D-shaped holes 30h are formed in the top component 30. The central support 30g also provides an internal attachment point for a valve 36. A blend radius 30j smooths the transition edge between the front face 30d and the rest of the external body of the top component 30. A blend radius 30k removes any sharp edges between the front face 30d and the openings 30h. The blend radius 30k helps minimize or eliminate any air turbulence that could be created by a sharp edge as air flows through the openings 30h. Holes 30m allow for air to enter a cavity within the top component 30. These holes 30m allow for outside air to contact a temperature sensor 42. While shown as an array of small holes, the number, shape, and size of the holes can vary. The blend radius 30n creates a smooth transition to the front in conjunction with the blend radius 30j. A groove 30p is cut or formed into an internal wall 30q of the top component 30. This groove 30p is optional but provides a stop point for engagement with a base 32, shown in later figures. The wall surface 30c defines two cutouts, each of which create a side face 30r, a side face 30s, and a top face 30t. A blend radius 30u eliminates any sharp edge at the bottom of the top component 30 here at the cutouts and around the lower circumference.

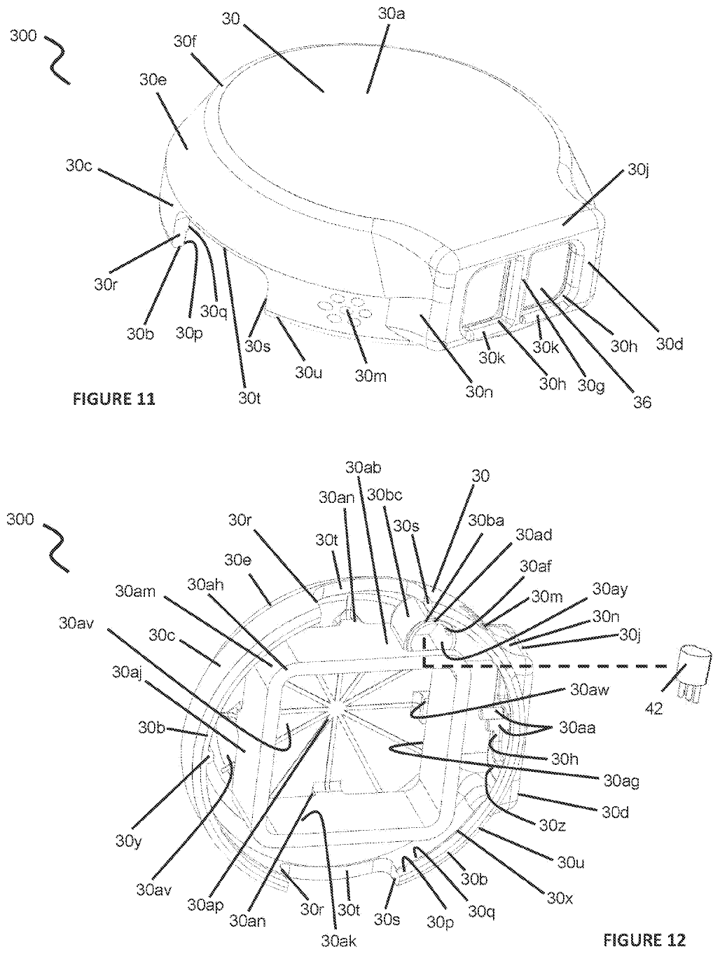

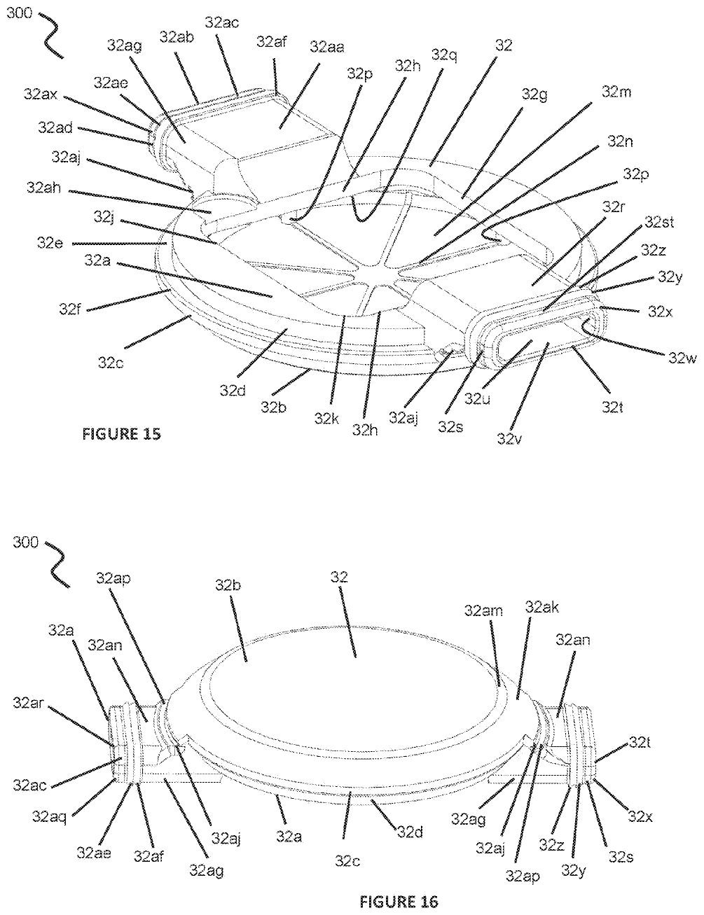

FIG. 12 shows internal details of the top component 30. The groove 30p, when formed or cut into the internal wall 30q, creates the edge and stop 30x. An optional alignment key 30y is shown to assist in aligning the top component 30 and a base component 32 (shown starting in FIG. 15). An inside face 30z provides a surface for engagement with the valve 36. Pins 30aa extend from the inside of the central support 30g to align and hold the valve 36. The pins are shown as round but they can be square or another shape, as well as be reduced to a single pin that is, in particular, not round to assure alignment of the valve 36 with the holes 30h. A fan holder of the top component 30 comprises sides 30ab and 30aj and inner pocket 30ak for receiving and holding a fan 40 (FIG. 14). The fan holder is suspended from the inside top 30av by at least one post 30an, to create a gap between the inside top 30av and a top of the fan holder 30ag. The post 30an can also have a lip 30aw, which helps position the fan 40 and prevents the fan 40 from being pushed too far into the inner pocket 30ak. By using additive manufacturing, the fan holder and other features shown in FIG. 12 can be printed in one piece. Of course, the fan holder can be formed separately and attached mechanically and/or with adhesive. The fan holder has radius 32am on the corners. A sensor holder 30bc comprises a pocket 30ay for receiving a sensor (shown diagrammatically with dashed lines) and at least one opening that connects to openings 30m. The sensor holder 30bc has a lower surface 30ad and a groove 30ba. The groove 30ba creates a circular portion that extends into the base 32, which helps to seal and insulate the sensor 42 so it read the outside air temperature and is substantially not reading the internal temperature of the device. The circular portion also substantially prevents air flow from the fan 40 from affecting the reading of outside temperature by the sensor 42. A blend radius 30n smooths a transition from the circular wall surface 30c to the front. While optional, depending on the material used for the top component inside ribs 30ap add strength while reducing overall thickness.

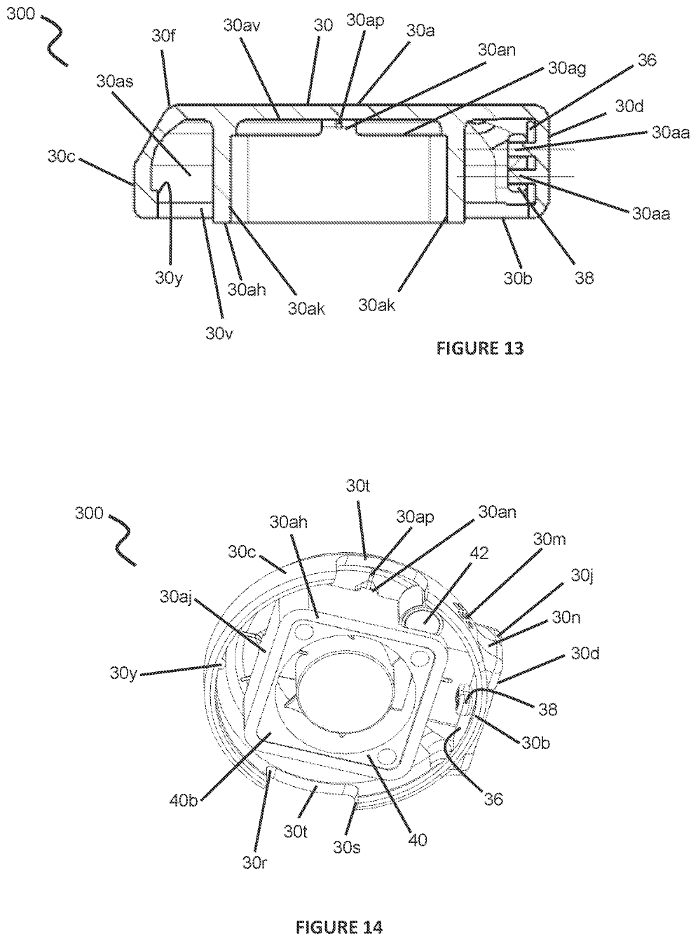

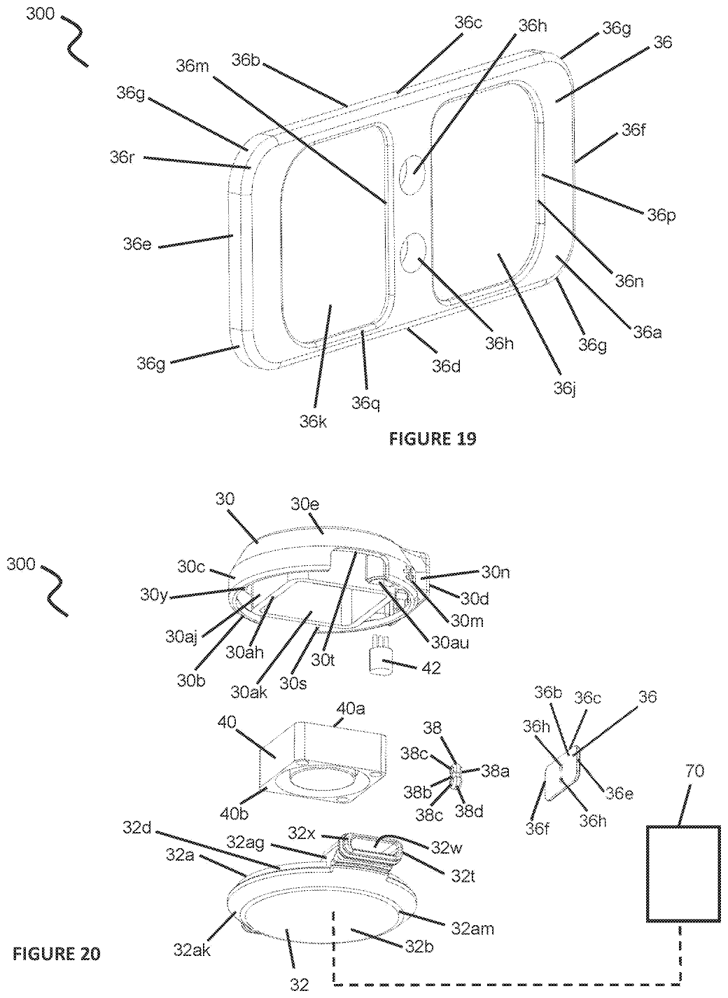

FIG. 13 shows a sectional view of the top component 30. The valve 36 in this embodiment is a flexible membrane that is located over pins 30aa. The valve 36 is shown in FIG. 19. The flexible membrane of the valve 36 is held in position through the pins 30aa and is secured into position by a retainer 38 that slides over the pins. In an alternative exemplary embodiment, the pins 30aa can have at least one barb or feature such that, when the flexible valve 36 is slid over the pins 30aa, the membrane expands to accept the barbs or feature and then returns towards its steady state size to lock the membrane onto the pins 30aa. FIG. 13 also provides a better view of the air gap between the inside top 30av and the fan holder top 30ag. As discussed above, the pins can be singular and/or of other shapes.

FIG. 14 shows a top component 30 of the apparel temperature control system 300 with the fan 40 and the sensor 42 installed. The fan 40 has a lower face 40b. Air flow in this embodiment is configured such that the fan 40 pulls air in through the valve 36, through the air gap above the fan 40, through the fan 40, and out in the direction of the fan bottom face 40b. The wires from the fan and sensor (not shown) can be connected directly to the control circuit. The control circuit containing the CPU and circuit board can be placed in a different location such as a pocket in front, side, or back, and can contain the battery as well. Miniature electronics and control circuit can also be placed within the temperature control unit itself. One reason for placing the fan 40, the sensor 42, and the control circuit in the top component 30 is to allow the top component 30 to be removable when washing the fabric or material to which the apparel temperature control system 300 is attached; this avoids submerging the electronic components of the apparel temperature control system 300 fan as well as allows for easy replacement of any of the fan 40, the sensor 42, and the valve 36, if needed. Any additional electrical components, such as LED indicators or readouts, can also be contained in the top component 30. Pulling off the top component 30 exposes a connector (e.g., a multi-pin electronic connector) that can be manually disconnected; however, in a particular embodiment, non-illustrated electrical contacts are provided on the top component 30 and the base 32 that automatically disengage when the top component 30 is removed from the base 32 and automatically engage when the top component 30 is connected to the base 32. These contacts can be added as separate conductive contacts or can be printed in place with conductive polymers, e.g., used in 3D printing. When the top component contains only the fan and sensor, and a separate holder contains the CPU, battery, and other components, the top component and separate holder can be removed prior to washing. A waterproof fan and sensor would allow component 30, fan, and sensor to remain in place during washing.

FIGS. 15, 16, and 17 show the base 32 of the apparel temperature control system 300. In FIG. 15, the base 32 has a top face 32a, a bottom face 32b, and an outer surface 32c. A cylindrical extension 32d is smaller than the outside diameter of the outer surface 32c, creating a lip 32e. A blend radius 32f eliminates a sharp edge at the intersection of the lip 32e and the outside diameter of the outer surface 32c. An opening formed or cut through top face 32a in this embodiment is square and creates surfaces 32h, 32g, and 32j. The corners are radiused with corner radii 32k. The thickness of the top extends from the top face 32a to an undercut face 32q, which leaves a gap between the undercut face 32q and an inside bottom face 32m. Optional ribs 32n allow for reinforcement of the bottom and allow the bottom to be thinner. Posts 32p provide support to the top of the base 32, which posts 32p assist in printing the part with a 3D printer. Alternatively, the base 32 can be broken down into two or more pieces and then assembled. This could make the posts 32p unnecessary, as would different 3D printing techniques. A rectangular section 32r extends outward from base 32 and has side faces 32s and top and bottom faces 32st. This defines outside dimensions of the rectangular section 32r while internal top and bottom face 32v and side faces 32w define the internal dimensions of a rectangular passageway 32u in the rectangular section 32r. The internal passageway 32u opens up into the gap between the undercut face 32q and the inside bottom face 32m to permit air flow therebetween. Barbs 32y and 32z (e.g., FIG. 16) assist in holding fabric or tubing onto the base 32. Such attachment can also be accomplished without barbs by using various adhesives, for example. The opposite side of the base 32 has the same configuration of the rectangular section 32aa with a front face 32ab and a top face 32ac. A side face 32ad is blended with a radius 32ax on each corner to avoid any sharp edges. Barbs 32ae and 32af provide mechanical holding capability to rectangular section 32aa. Blend radii 32ag eliminate any sharp edges. A pocket 32ab (FIG. 15) acts as a receiver for the sensor holder 30bc and the sensor 42 of the top component 30. This helps create a seal to isolate the sensor holder 30bc to be exposed only to the environment outside the system 3300 and air coming into the top component 30 through the valve 36. This configuration allows outside air temperature to be measured without interference from internal airflow created by the fan 40 or coming from inside the base 32. A groove 32aj is provided for an additional attachment point for fabric or other materials.

FIG. 16 shows the bottom of the base 32. In this example, a chamfer 32ak runs from the outer diameter of the outer surface 32c to the bottom face 32b, with a blend radius at the intersection to avoid any sharp edges. Chamfer 32ak is optional but reduces the amount of weight in the component while also reducing a diameter of the bottom face 32b. When placed such that the bottom face 32b is inside clothing, a smaller diameter of the bottom face 32b will make the system 300 more comfortable to wear. The bottom faces 32an of the rectangular sections 32aa are positioned to side slightly above fabric or material within groove 32aj. The fabric or material contacts flat faces 32ap, which is level to the upper surface of groove 32aj. Rectangular section 32r has a front face 32t and a radius 32x to break any sharp edge.

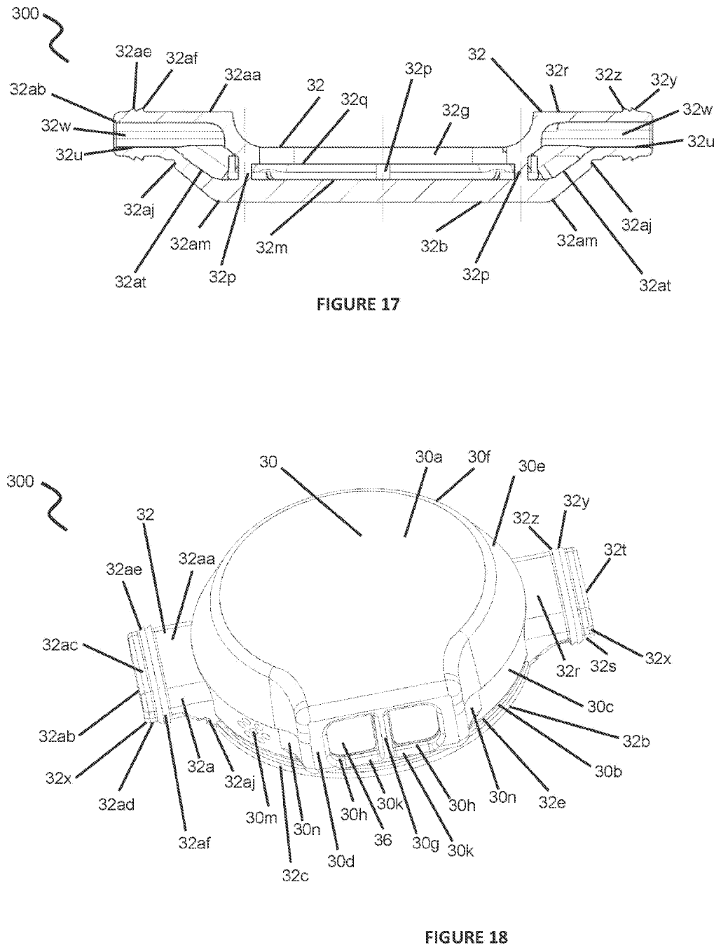

FIG. 17 shows a sectional view of the base 32. Air passageways 32u in the rectangular section 32r connect directly with passageways 32at, which open into the gap between the undercut face 32q and the inside bottom face 32m. The posts 32p, which support the undercut face 32q, are present to assist in additive manufacturing through 3D printing. Various manufacturing techniques may not require the posts, such as support material that can be removed (e.g., water-soluble materials). Also, the top component 32 can be made from more than one part, to create a multi-part assembly that can be molded rather than printed.

FIG. 18 shows the apparel temperature control system 300 with the top component 30, the bottom component 32, and the valve 36 connected together as a self-contained, clamshell-type assembly. For attachment to apparel or another piece of material, a gap is shown between bottom face 32b and the lip 32e for receiving a thickness of the material. The base 32 slides within the top component 30 to allow the gap to vary depending on the thickness of the material. In this example, the fabric or material is sandwiched between the bottom face 32b and the lip 32e to secure and attach the assembly. Of course, a retaining ring or other retainer can be added to or built into the base 32 as an alternative way to attach the base 32 independent of the top component 30.

FIG. 19 shows the valve 36 used in the apparel temperature control system 300. The valve 36 is a flexible polymer component having a top face 36a, a bottom face, 36b, a top edge 36c, a bottom edge 36d, a right side edge 36e, and a left side edge 36f. The edges are blended with radii 36g. At least one hole 36h creates the measures to attach the valve 36 to the top component 30 and to align the valve 36 with the holes 30h of top component 30 when fit over one or more pins 30aa. Recesses 36j and 36k add additional flexibility when necessary. Of course, the recesses may not be necessary depending on the material used to make the valve. The inside of the recess 36k creates a face 36m, which varies in dimensions according to the depth of the pocket 36k. The inside of recess 36j also creates face 36n, which varies in dimensions according to the depth of the pocket 36j. Additional blend radii 36p and 36q smooth the transition edges, and radii 36r blend the intersection of side faces with top face 36a.

FIG. 20 is an exploded view of the apparel temperature control system 300 and illustrates how the components are assembled. The fan 40 is fit within the top component 30 and is a tight fit with opening 30ak (e.g., a press-fit). Air flows from the top face 40a towards lower face 40b. It is beneficial to have an airtight seal between the sides of the fan 40 and the opening 30ak of the top component 30 to minimize or eliminate any air leak. Air is pulled in through the valve 36 via the fan 40 and is ejected out of the rectangular ports in the base 32. Although the valve 36 can be retained by features on the pin(s) 30aa, it can also be retained with a retainer 38 that fits over the pins 30aa. The retainer 38 has a front face 38a, a back face 38b, holes 38c, and sides 38d. The retainer 38 can be secured to the pins 30aa with a press fit, an adhesive, and/or melting of the pin 30aa. The temperature and/or humidity sensor 42 fits within the opening 30au. In a particular embodiment, wires or contacts contact the pins at the top and are wired appropriately. The bottom of the pocket 30ak for retaining the fan 40 extends far enough down to fit within the square cutout in the base 32. This configuration provides an ideal way to place non-illustrated electrical contacts along the face 30aj and on the corresponding inside side of the base rectangular cutout; in this manner, when the top component 30 is attached to the base 32, the contacts conduct to wires located or coming from the base 32. As discussed previously, such a configuration allows the top component 30 to be removed along with the electrical components, should the apparel or material need to be washed. Of course, waterproof components can be used to avoid this issue, and the fan 40 and the sensor 42 can be placed in the base 32 rather than in the top component 30. A removable waterproof cover can also be used for the purposes of washing the apparel or desired item. Wires from the base 32 connect to the non-illustrated control circuit 70 in the front, back, or side of the apparel.

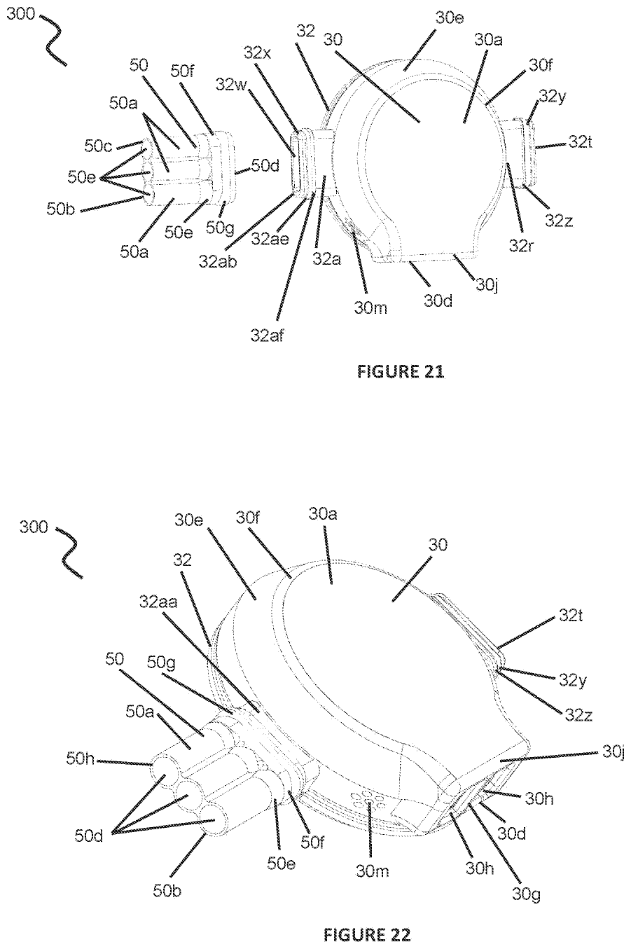

The air coming out through the valve 36 and exiting the passageway 32u in the rectangular section 32r of the base 32 can exit into one rectangular tube per side or be subdivided into multiple tubes to distribute air flow in various locations as needed. In FIGS. 20 and 21, the apparel temperature control system 300 includes a connector 50 that divides flow exiting from the base 32 into three parallel tubes. The connector 50 has a front face 50a, a back face 50b, an outlet face 50c, an inlet face 50d, a transition zone 50e, and a connector section 50f and 50g. The area defined by the connector section 50f, 50g is a region that that slides over the barbs 32y, 32z of the rectangular section of the base. In most cases, a feature for this is not required, as material or polymers have the ability to stretch and fit over the barbs 32y, 32z. Nonetheless, it is included here as an example of a feature that can be molded or formed in the connector 50. FIG. 22 shows the connector 50 attached to the base in this manner. While the embodiment of the connector 50 in FIGS. 21 and 22 is representative, the number of tubes as well as the shape can be altered as needed.

The apparel temperature control system 300 is configured to be as small and as light as possible. When the unit is off, and the speed (RPM) of the fan 40 is at 0, the valve 36 remains closed. This state seals air input from air in the outside environment of the apparel. Without a valve 36, if the port is open, cold, or overly warm, air can enter through the assembly. The valve 36 opens when a vacuum pulls at the valve 36. In exemplary embodiments, the valve 50 is flexible and resilient. However, there are other types of valves that can be used, such as ball valves, duckbill valves, plate on a spring, etc. As the fan 40 has the ability to output a range of cubic feet per minute of air, the air input openings and the valve are configured to overly restrict air flow, which would compromise the ability of the fan 40 to function as needed.

The top component 30 is effectively sealed from the air outputs of the base 32. When the fan 40 is turned on, air is pulled through the valve 36 and then through top openings around the valve holder in the top component 30. The air is then forced into the base 32 and out the rectangular passageways 32u in the rectangular sections 32r. The velocity and volume of the air is directly related to the RPM of the fan 40. The RPM is controlled through the controller that monitors the temperature sensor(s) and turns on the fan 40 and changes speed according to the controller software. The specifics of when the fan 40 turns on and off and what the temperature trigger is, can be predetermined, altered by the user, or automatically adjusted by predictive analytics or by artificial intelligence. The controller controls the RPM of the fan 40 from 0 to a maximum, adjusting as needed to maintain a desired temperature. Together, the fan, the sensor, and the controller (as well as any optional heating element(s)) comprise a cooling subassembly of the apparel temperature control system 300.

The rectangular air exit ports in the base 32 are shown in the apparel temperature control system 300 in a raised position, or above the fabric. This allows for a minimum of the base to be under the fabric, which is ideal for a very thin piece of clothing, e.g., a jacket or shirt. The configuration requires that at least a portion of the exit tubing 50 is on the outside surface of the jacket or fabric. For a thicker jacket or application, the exit ports can be located below the fabric or inside the jacket face, as examples. Thus, the location of the exit ports can be altered as needed to fit the application.

The connector 50 can have multiple tubes that extend outward and terminate at the same length or at variable lengths, which allows for airflow to be directed to various parts of the clothing, either internally or externally. For external tubes, a small opening, port, or nozzle can connect the inside of the tube to the inside of the jacket to allow for airflow. The nozzles can also be of different sizes to allow different amounts of air or pressure in one or more tubes as needed. While the apparel temperature control system 300 is shown with two air exit ports, this can be reduced to one, or the number of ports can be greater than two. Further, the location of the airflow ports can be made different than at opposing sides (e.g., at an angle to one another, next to one another).

It is noted that, the smaller the port cross-section is, the more resistance there is to the free flow of air. With the two ports, one port can be direct to provide air on the front of the clothing and the other on the back, or one for the left side and one for the right, or any combination thereof. The air exit ports can also be of the same or different sizes. Different sizes can be used to reduce air flow to one section or set of tubes or increase air flow to a section or set of tubes. Reducing the size of the exit port opening increases the pressure required to move past the opening(s), thereby decreasing air flow. As it is desirable to use only one fan to minimize the overall size of the system and to keep power draw to a minimum, the embodiments described and shown are beneficial ways to control air distribution should it be necessary. Tubing size can also be used to control air distribution in the same manner. However, it is possible to use more than one air control unit and use two or more fans to control air to various regions of the apparel, blanket, etc. Furthermore, multiple fans can be controlled from the same sensor data and control circuit. The multiple air control units can also be independently controlled by separate circuits and sensors.

For the tubing that extends from connector 50, it is beneficial for the tubing to be flexible, particularly when the jacket, clothing, apparel, or other item is also flexible. This allows the tubing to move with the wearer and be more comfortable during use. It is also desirable for the tubing to resist kinking and/or occluding. While various exiting tubes, such as those constructed from silicone, polyurethane, or other polymers are flexible and can be used, weight is an issue. For athletes, every gram is more weight they must carry, and existing tubing can be relatively heavy. To save weight and keep the tubing flexible, a novel approach is provided for herein. Tubing, which can include the end connector 50, is constructed from a flexible fabric. For example, stretchable polyester and spandex are combined to create a four-way stretchable fabric. The fabric is then coated in polyurethane, which is also flexible and stretchable. The polyurethane coating seals the pores in the fabric to create a flexible and airtight or substantially airtight fabric. This fabric is then formed into a tube and sewn at the seam. The seam can also be sealed by other measures in place of sewing, such as with fabric cement in addition to or in place of sewing. This configuration creates a very lightweight flexible tube for constructing the air passageways in the system. Manufacturing techniques can also weave this fabric tube in one piece. In addition, the tubes can remain in a flattened shape to expand only when under air pressure. In an exemplary embodiment, the fabric comprises between approximately 60% to approximately 95% polyester and approximately 40% to approximately 5% spandex, or between approximately 75% to approximately 90% polyester and approximately 25% to approximately 10% spandex. In a particular embodiment, the fabric is approximately 85% polyester and approximately 15% spandex. Other combinations can be used as well as other fabrics and coatings.

For curved sections of the tubing formed from fabric, the curve can be formed over a curved mandrel to allow the tube to have at least a portion of the curve built in after bonding and/or sewing. The curved section can also be created by cutting the fabric into a curved section in the area desired. In such a case, it may be beneficial to cut two pieces of fabric into the curved shape and then sew or bond the two seams together. Should it be desired to use a single tube and then curve that tube, and if air pressure through the section is insufficient to inflate the tube, a flexible coil can be inserted into the curved section to restore the opening.

An element of the system is to keep the assembly as small as possible but also provide maximum air flow. Taking these characteristics into account, it is possible to alter the geometry of the herein described and shown assemblies to place the fan at an angle relative to at least one air passageway. Such a configuration allows for better air flow with less turbulence without the need to increase height. In addition, this approach opens up the ability to increase air volume by utilizing a larger fan with a smaller thickness, as such a fan significantly improves air throughput. For example, a 20 mm×20 mm×8 mm fan can produce 1.3 to 1.6 CFM. In comparison, a 25 mm×25×6 mm fan can produce up to 3.1 CFM.

To take advantage of this property, an apparel temperature control system 400 is able to fit the larger fan in the body by changing the angle between the fan and the output lumen and by simultaneously providing larger openings and passageways for air. Angling the fan reduces the length of the fan holder while increasing the height but, because the larger fan is 2 mm smaller in thickness, this reduction compensates for the overall change in height while at least doubling the throughput of moving air.

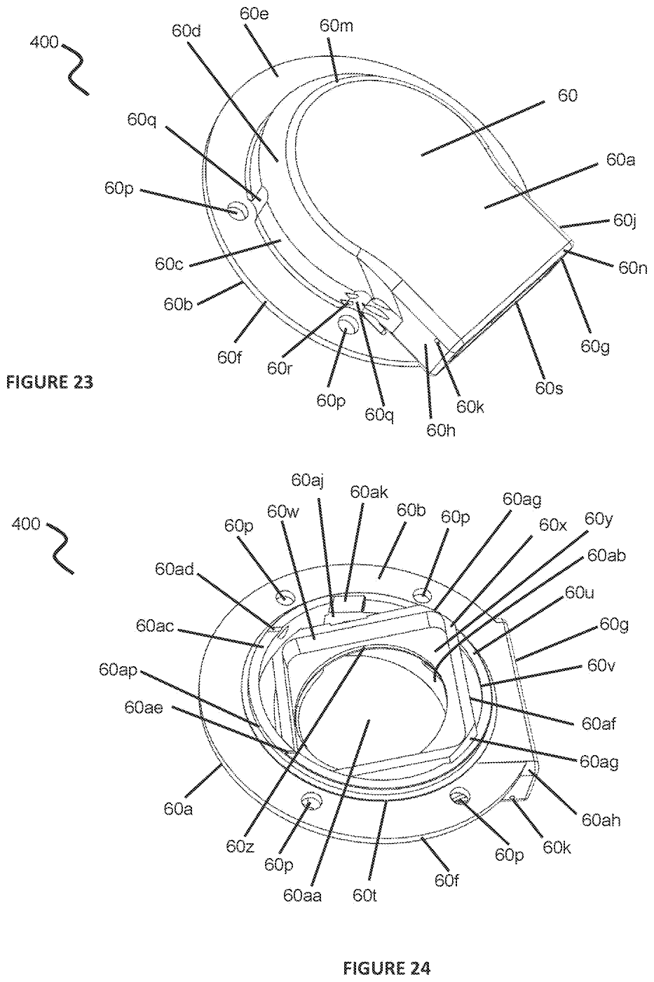

An angled fan version is described in an apparel temperature control system 400 shown in FIGS. 23 through 29. FIG. 23 shows top cover 60, which, in this exemplary configuration, contains the fan 40 and an external air temperature sensor or combined air temperature and humidity sensor. Of course, the fan 40 and sensor 42 can be positioned in the base 62. However, by including the electrical components in the top cover 60. The top cover 60 can be removed with all of these components when washing the clothing is required. The top cover 60 has a top surface 60a, a bottom surface 60b, a main body portion 60c, and, in particular, a chamfer or radius 60d between the top surface 60a and the main body 60c. A flange 60e is shown as part of the main body 60c. The flange 60e can also be a separate component that snaps into a non-illustrated groove on the main body 60c. The flange 60e has a face 60f. While shown here as cylindrical, the flange 60e can be any other shape. The main body 60c extends forward to a front face 60g, which is a rectangular extension having side faces 60h and 60j. A hole 60k allows for a pivot pin for valve 64. The hole 60k can be through, blind, or be replaced by internal features that hold the valve in the correct position. Blend radii 60m and 60n remove sharp edges. Holes 60p allow for the flange 60e to be retained to the bottom of the assembly by screws, for example. While shown here as holes, the assembly can be reversed such that the holes are threaded and the screws come in from the bottom. Small recesses 60q allow for clearance for the screw heads, where necessary. At least one hole 60r extends from the outside of the top component 60 to the inside pocket, which retains therein temperature sensor 42. Opening 60s extends from the front 60g to allow air to enter the top component 60 from an outside environment, e.g., air surrounding the outer surface of a piece of clothing. A pocket 60aj creates an isolated area away from the air coming into the fan 40 for retention of a temperature or combined temperature and humidity sensor. The pocket 60aj allows air to enter through openings 60r. Any additional space needed to insert sensor 42 into the pocket 60aj is created by the groove 60ak, which provides clearance so that the sensor 42 can be slid into position. Once sensor 42 is in position with wires attached, the pocket 60aj can be sealed to further isolate the sensor 42 from the main opening 60s. This configuration allows the sensor 42 to always receive outside air even when valve 64 is closed.

FIG. 24 shows the reverse or bottom side of the top component 60. A cylindrical extension 60t extends from the bottom surface 60b of the flange 60e. The configuration allows for alignment and fit within a hole cut into the fabric of the clothing, apparel, blanket, etc. An extension 60u has an outside surface 60ap, an inside surface 60v, and, in this example, a cutout 60ac with blend radii 60ad and 60ae at the ends of the cutout 60ac. The cutout 60ac allows for clearance with the bottom component 62. A pocket 60w having a lower surface 60y is dimensioned to hold the fan 40, in a particular exemplary embodiment, by press fit, but the fan 40 can also be adhesively or otherwise bonded in position. Pocket 60w formed into the top component 60 to hold the fan, leaves a top face 60x and a front face 60af. An opening 60z allows for the lower surface 60y to maintain a lip to control the proper depth of fan placement while allowing air to flow freely through the fan 40 from the front opening 60s. It is noted that the face 60y and the pocket 60w hold the fan 40 at an angle relative to the inside bottom face 60aa. This position allows an increase in the distance from the bottom of the fan 40 to the air channel and the inside bottom face 60aa as the fan 40 gets closer to the air opening 60s. The front corners 60ag of the outside feature containing the pocket 60w are rounded for better fit within the bottom component 62.

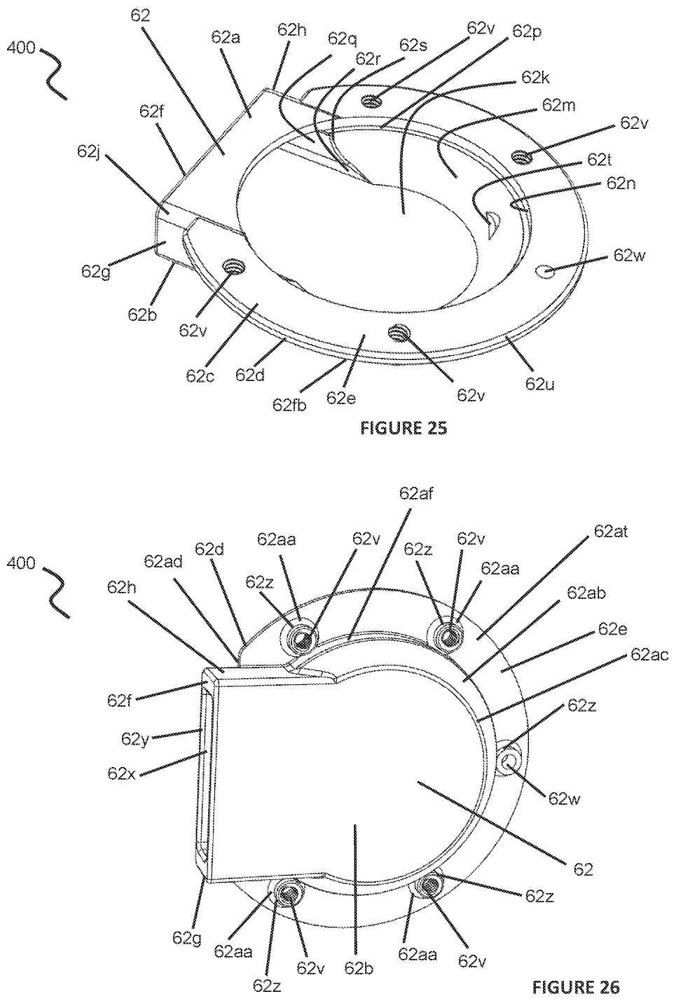

FIG. 25 shows the bottom component 62 of the apparel temperature control system 400. The bottom component 62 has a top surface 62a and a bottom surface 62b. Flange 62e has a top surface 62c and a lower surface 62at. The flange has a side wall 62d, which is cylindrical in this example, with a lower surface 62e. The rectangular nose has a front face 62f, side walls 62h, 62g, and blend radii 62j. The inside of the bottom component 62 is hollow to create as much of an open volume for air movement as possible, which hollow creates an internal bottom surface 62k. A blend radius 62m, creates a smooth passage to reduce any air turbulence with reducing wall thickness. Of course, this surface can be tapered, cylindrical, rectangular, have a smaller blend radius, or any combination thereof. A groove 62n creates an opening to receive the cylindrical extension 60t of the top component 60, to help align the bottom component 62 and the top component 60 while also providing a seal between these two components 60, 62. Fabric sandwiched between the two components 60, 62 also provides for an effective gasket that can be enhanced by adhesive or sealant if needed or desired. A blend radius 62u prevents any sharp edge of the flange from contacting the fabric. Threaded holes 62v allow for screws to be passed through the holes 60p in the top component 60 and tightened in the threads 62v to pull the assembly of the apparel temperature control system 400 together. As discussed herein, the thread and hole configuration can be reversed such that threads 62v are in the top component 60 and the holes 60p are in the bottom component 62. An alignment pin hole 62w is optional to help align the top and bottom components prior to screw insertion. The pin hole 62w can also be threaded, should additional screw fixation be needed. Any additional clearance between the top component 60, the fan 40, and the bottom component 62 can be created by pockets, such as 62t, which, in this example, allow for clearance with the front of the fan holder edges 62ag.

FIG. 26 shows a bottom view of the bottom component 62. An opening 62x provides a passageway for air to exit from the inside of the bottom component 62 into an inside environment, e.g., within a piece of clothing. A radius 62y blends the opening 62x and the front face 62f to eliminate any sharp edge. To increase a number of threads and maximize thread purchase, small studs or extensions 62z provide additional length without the need for additional thickening of the entire flange. A blend radius 62aa reinforces and eliminates any stress risers between the small studs 62z and flange 62e. A chamfer or radius 62ab blends the main lower body 62af with bottom surface 62b. A small radius 62ac is also provided to break any sharp edge where a chamfer meets the bottom surface 62b.

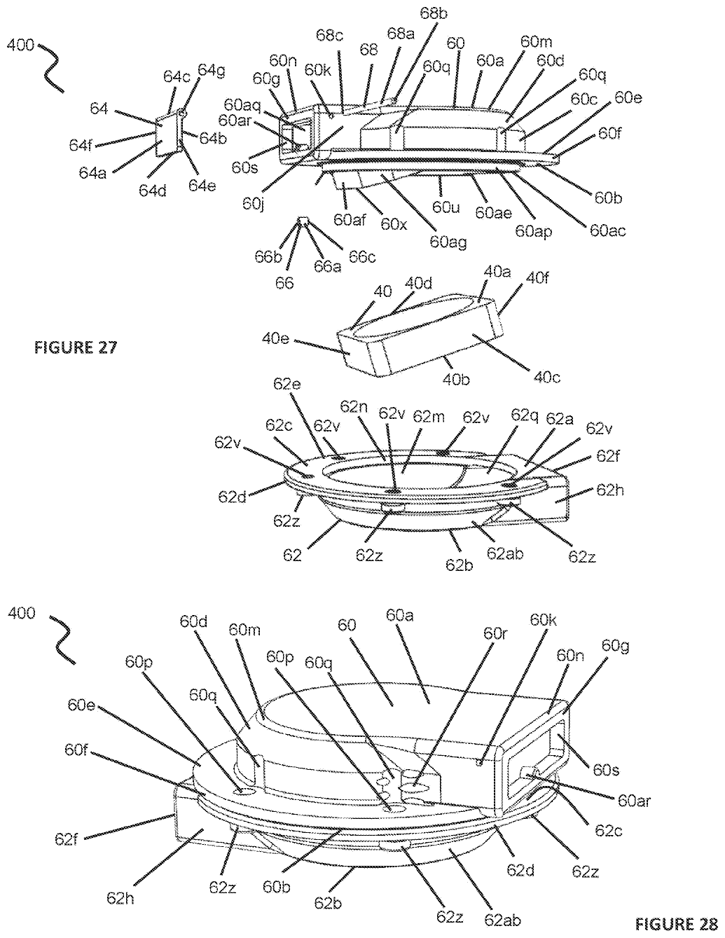

FIG. 27 shows an exploded view of the entirely assembly of the apparel temperature control system 400. A valve 64 having a front face 64a, a back face 64b, a top surface 64c, a bottom face 64d, a first side 64e, and a second side 64f has a hole 64g to accept a pivot pin 68. The pivot pin 68 has an external surface 68a and ends 68b, 68c that fits within the hole 60k to allow valve 64 to pivot and open/close. This flap-type valve is discussed in an earlier embodiment and, in this example, allows for a relatively large opening for air to enter. The valve 64 is configured to be in a normally closed position (steady state), such that fan suction opens the valve. Keeping the valve closed when the fan 40 is off can be done by gravity, and the geometry of the top surface 64c where it contacts the inside of the top component 60. The valve 64 can also have a flexible construction, such that the valve 64 is fixed in the closed position but is flexible enough for the air suction to pull the valve 64 open. There are other ways to construct this valve 64, including electromechanical measures, such as a micro-solenoid. In any configuration, it is desirable to have the valve 64 closed when the fan 40 is off to prevent outside air from entering. The valve 64 fits within the pocket 60aq of the top component 60. Another way to keep the valve 64 closed when the fan 40 is off utilizes a small magnet 66. The magnet 66 has an outside surface 66a, a front face 66b, and back face 66c. The magnet 66 sits within a cavity within a top component magnet retainer 60ar. By placing a small magnetically attractable material, such as an iron-based material, in or attached to the valve 64, when the valve 64 is close to the magnet 66 and the suction from fan 40 is insufficient, the valve 64 will be attracted to a closed position or state. Different sized magnets or multiple magnets can be used to adjust this force. Small magnets from Neodymium and other materials are available.

The angled fan 40 has a top face 40a facing towards the top component 60, a bottom face 40b facing the bottom component 62, a first side 40c, a second side 40d, a front face 40e, and a back face 40f such that it fits within the fan holder in the top component 60. The fan holder also can be in the bottom component 62 rather than the top component 60. Screws for attaching the top component 60 to the bottom component 62 are not shown. The screws can also be replaced by rivets, or there can be a combination of both. In a desirable embodiment, the top component 60 can be removed should the fan 40 or sensor 42 need to be replaced, or the item washed, and in such a case, the removable fasteners are preferred over permanent ones.

FIG. 28 shows the apparel temperature control system 400 in a fully assembled state. The fabric (not shown) is sandwiched between the flange face 60b of the top component 60 and the flange face 62c of the bottom component 62 in a clamshell-type configuration. Screws hold the components 60, 62 securely together. Attaching the components 60, 62 to the fabric or material without the need for a flange is also possible through adhesives, plastic welding, and/or other mechanical and chemical approaches. Also, a single flange can be used on the bottom component 62 such that it can be fixed to the fabric or material while permitting the top component 60 to snap into the bottom component 62 through retaining tabs or a retaining ring within a groove. As discussed in previous embodiments, adding a heating coil or element to the assembly can be done such that the controller can turn on heat when the fan 40 comes on. This description above is incorporated by reference herein and is not repeated. Another option to save energy is to have a second assembly with a fan and a heater without a valve to pull already somewhat warmed air within the jacket and warm it further without pulling in colder outside air. When a jacket or apparel is worn, body heat warms the air within the jacket and this air is generally warmer than the outside air. By using this pre-warmed air and supplementing it with additional heated air from the temperature control system, the system becomes more efficient and requires less time to raise the temperature, as the temperature differential is less than warming the outside air. For example, if the outside air temperature is 32 degrees F., the body heated air temperature within the jacket is 60 degrees F., and the desired set temperature is 90 degrees, by using the air within the jacket, the heater only needs to raise the temperature 30 degrees F. Using outside air, the temperature control unit needs to raise the temperature 58 degrees F., which takes longer and uses more energy. Using a second assembly allows the first to unit to remain with the valve closed and prevent outside air from entering the internal air space within the apparel. As above, the fan, the sensor(s), and the controller (as well as any optional heating element(s)) comprise a cooling subassembly of the apparel temperature control system 400.

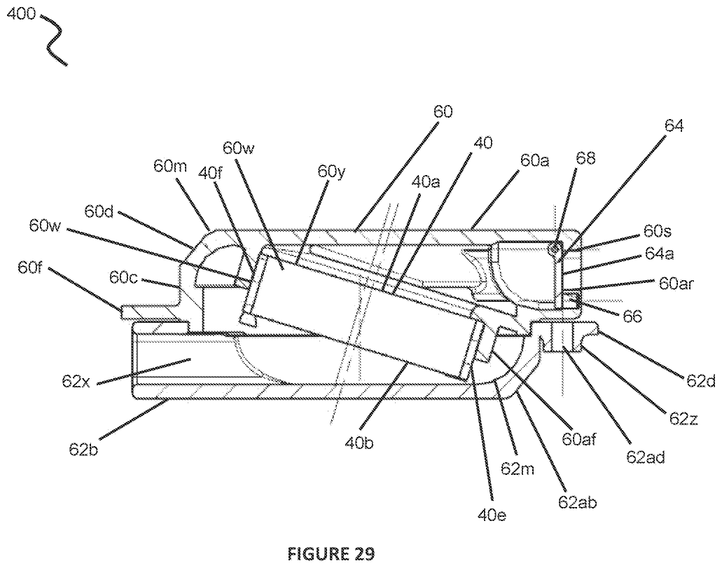

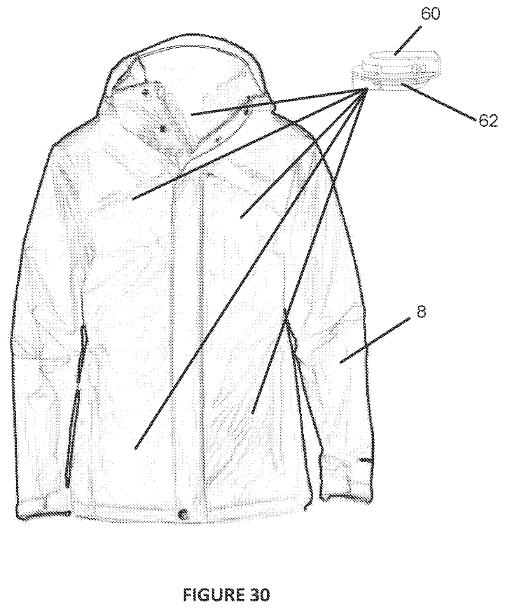

FIG. 29 shows the apparel temperature control system 400 of FIG. 28 in a cross-section. This illustrates the fan 40 and fan holder are angled relative to the air passageway 62x in the bottom component 62 and the front opening 60s in the top component 60. As can be seen, the valve 64 sits within a cavity within the top component 60 with clearance to allow the valve 64 to move as necessary. By changing an angle of the fan 40 and a size of the air passageways, the volume of air that can be moved and the efficiency of the system 400 can be altered as needed with the understanding that such changes may increase the overall height of the assembly.

For the top component and the base, as well as other components shown herein, there are multiple materials and manufacturing approaches possible to construct the components. As discussed in the embodiments, one ideal way to manufacture the components is by additive manufacturing. This allows for the elimination of molds and creates material possibilities and easier changes and modifications which may be needed depending on the apparel or item. 3D printing is readily available and allows for complex part manufacture. Various polymers, including ABS, ASA, PETG, carbon-fiber-reinforced materials, PEEK, PLA, metals, and others are available. Titanium and aluminum are lightweight metals that can be used for this application. Materials and colors can be combined to create unique structures. Water soluble support materials allow for support of the printing structure for complex shapes and can be easily removed after printing. This can eliminate the need for support pins, such as those shown in the base 32. Standard manufacturing techniques can be used, such as molding and machining, and making the embodiments herein in multiple pieces to make such manufacturing processes possible.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or configuration. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined by the following claims.

The invention has been described in an illustrative manner, and it is to be understood that the terminology, which has been used is intended to be in the nature of words of description rather than of limitation. Many modifications and variations of the present systems, apparatuses, and methods are possible in light of the above teachings. It is, therefore, to be understood that within the scope of the appended claims, the invention can be practiced otherwise than as specifically described.

What is claimed is:

1. A self-contained apparel temperature control system, comprising:
a base body defining a top component opening and configured to attach to apparel, the base body comprising;
a valve in a normally closed position;
an internal air passageway fluidically connecting the opening to the valve; and
electrical body contacts;
a removable top component comprising;
a fan holder configured to secure a fan at an angle;
a sensor holder configured to secure at least one sensor;
a breathable filter positioned and configured to permit air to pass into the top component from the environment while creating a barrier to water from entering the fan and, consequently, any apparel to which the base body is attached;
electrical component contacts configured to connect to at least one of the fan and the at least one sensor when the top component is engaged with the base component, the electrical body contacts, the top component configured to conduct power and data to the electrical component contacts;
wherein:
the base body and the top component define an air flow conduit;
the base body and the top component form a removable top assembly that, responsive to being removed, the electrical body contacts, the top component including the filter, the electrical component contacts, and any devices held in the fan or sensor holders are away from the apparel to permit washing of the apparel; and
air flow through the base body, the top component, and the valve is prevented until powered air is supplied through the fan holder sufficient to open the valve.

2. The temperature control system according claim 1, wherein the fan holder comprises an input side and an output side. and further comprising:
at least one temperature sensor attached at the sensor holder and configured:
to measure a temperature value of the inside environment; and
to electronically transmit the measured temperature value;
a fan attached at the fan holder and configured to move air from the input side to the output side; and
a controller electronically connected to the fan and to the at least one temperature sensor, the controller programmed:
to receive the measured temperature value at a constant sampling rate to create measured temperature values;
to compare a set point temperature value with the measured temperature values;
to process the compared values and predict a rise of temperature over time to generate a fan turn-on signal before the set point is reached; and
control revolutions per minute of the fan according to the rise of temperature over time and, thereby, maintain a lowest revolutions per minute that minimizes power draw.

3. The temperature control system according claim 1, wherein the airflow passageway defines an outside environment inlet and an inside environment outlet and which further comprises a piece of apparel, the outer and inner components clamped together on opposing sides of the apparel, the outer environment being the environment outside the apparel and the inner environment being the environment inside the apparel, and, responsive to being turned on, the fan forces air into the inner environment from the outer environment.

4. The temperature control system according claim 3, wherein the apparel comprises at least one of openings and channels fluidically connected to the inside environment outlet such that, responsive to the fan being turned on, air is forced by the fan through the at least one of openings and channels to be distributed about various locations within the inner environment.

5. The temperature control system according claim 1, wherein:
the at least one temperature sensor comprises an inside environment temperature sensor and an outside environment temperature sensor;
the inside environment temperature sensor is configured:
to measure an inside temperature value of the inside environment; and
to electronically transmit the measured inside temperature value to the controller;
the outside environment temperature sensor is configured:
to measure an outside temperature value of the outside environment; and
to electronically transmit the measured outside temperature value to the controller; and
the controller is electronically connected to the fan and to the inside and outside temperature sensors and is programmed:
to receive the measured inside and outside temperature values;
to compare the measured inside and outside temperature values; and
to turn off or on the fan dependent upon a comparison of at least two of the set point temperature value, the measured inside temperature value, and the measured outside temperature value.

6. The temperature control system according claim 1, wherein:
the at least one temperature sensor comprises a humidity sensor configured:
to measure a humidity value of the inside environment; and
to electronically transmit the measured humidity value to the controller; and
the controller is programmed:
to receive the measured humidity value;
to compare a set point humidity value with the measured humidity value; and
to turn off or on the fan dependent upon a comparison of the set point humidity value with the measured humidity value.

7. The temperature control system according claim 1, wherein the controller is programmed:
to periodically receive the measured temperature value and to compare the set point temperature value with the measured temperature value; and
to turn off and on the fan periodically to keep the measured temperature value at a given value.

8. The temperature control system according claim 7, wherein the given value is user-adjustable.

9. The temperature control system according claim 1, wherein:
the fan is a variable speed fan; and
the controller is programmed to control a speed of the variable speed fan to optimize a volume of air entering the inside environment.

10. The temperature control system according claim 6, wherein the controller is programmed:
to keep the interior temperature at a given temperature; and
to keep the interior humidity at a given humidity.

11. The temperature control system according claim 10, wherein the given temperature and the given humidity are each user-adjustable.

12. The temperature control system according claim 1, which further comprises:
a wireless communication device operatively connected to the controller and configured to receive the set point temperature value and provide it to the controller; and
a remote control configured to wirelessly transmit the set point temperature value to the controller.

13. The temperature control system according claim 1, which further comprises a plurality of apparel temperature control devices each comprising the body and the cooling subassembly.

14. The temperature control system according claim 13, which further comprises:
wireless communication devices each operatively connected to the controller of each of the plurality of temperature control devices and configured to receive a set point temperature value and provide it to a respective controller; and
a remote control configured to wirelessly transmit the same set point temperature values to the wireless communication devices.

15. The temperature control system according claim 13, which further comprises:
wireless communication devices each operatively connected to the controller of each of the plurality of temperature control devices and configured to receive a respective set point temperature value and provide it to a respective controller; and
a remote control configured to wirelessly transmit set point temperature values to each of the wireless communication devices.

16. The temperature control system according claim 1, which further comprises at least one heating element operatively connected to the controller, the controller programmed to power the heating element dependent upon a comparison of the set point temperature value with the measured temperature value.

17. The temperature control system according claim 1, wherein the airflow passageway defines an inside environment outlet and which further comprises tubing fluidically connecting the inside environment outlet to different locations within the inside environment.

18. The temperature control system according claim 1, wherein the tubing is constructed from a flat sheet of material formed to create a flexible tube and coated with a non-porous flexible coating.

19. A self-contained apparel temperature control system, comprising:
a base body defining a top component opening and configured to attach to apparel, the base body comprising;
a valve in a normally closed position;
an internal air passageway fluidically connecting the opening to the valve; and
electrical body contacts;
a removable top component comprising;
a fan holder configured to secure a fan at an angle;
a sensor holder configured to secure at least one sensor;
electrical component contacts configured to connect to at least one of the fan and the at least one sensor when the top component is engaged with the base component;
wherein:
air flow through the base body, the top component, and the valve is prevented until powered air is supplied through the fan holder sufficient to open the valve.

20. The temperature control system according claim 19, wherein:
the body is sized to be attached to apparel of a user;
the outer component is configured to attach to the inner component with:
the outer component adjacent an outer surface of the apparel in the outside environment of the user; and
the inner component adjacent the inner surface of the apparel in an inside environment of the apparel adjacent the user;
the measured temperature value is a temperature of the inside environment; and
responsive to being turned on, the fan moves air from the outside environment to the inside environment.
